(19) United States
(12) Patent Application Publication
(10) Pub. No.: US 2009/0092037 A1
(43) Pub. Date: Apr. 9, 2009

(54) Wireless Interactive System and Method

(76) Inventor: Zion Hadad, Rishon Lezion (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/195,415

(22) Filed: Aug. 21, 2008

Related U.S. Application Data
(62) Division of application No. 09/624,237, filed on Jul. 24, 2000, now abandoned.
Application No. 09/624,237 is a continuation-in-part of application No. 09/399,109, filed on Sep. 20, 1999, now Pat. No. 7,133,352.
Application No. 09/399,109 is a continuation-in-part of application No. 09/493,662, filed on Jan. 28, 2000, now Pat. No. 6,985,432.

(51) Int. Cl. H04J 11/00

(52) U.S. Cl. 370/207

(57) ABSTRACT

In a wireless broadband system comprising a base transmitting to a plurality of subscribers, means for achieving an interactive bi-directional system comprising transmitter means in the subscriber system for transmitting signals which are orthogonal to the signals transmitted from other users arriving at the base station. A method for achieving an interactive bi-directional system comprising the steps of: A. using a subscriber transmitter with an upstream physical layer based on the use of a combination of Time Division Multiple Access and Orthogonal Frequency Division Multiple Access; B. dividing the upstream into a number of “time slots” as defined by the MAC layer; C. controlling, in the MAC layer, the assignment of subchannels and time slots by bandwidth on demand and Data Rate on demand.

### CROSS-REFERENCE TO RELATED APPLICATIONS

The present application is related to the application No. 129186 filed on Mar. 25, 1999 in Israel and entitled “Bi-Directional Communication Channel”.

The application is a continuation in part from U.S. patent application Ser. No. 09/399,109 filed on Sep. 20, 1999 and entitled “Bi-Directional Communication Channel”.

The application is also a continuation in part from U.S. patent application Ser. No. 09/493,662 filed on Jan. 28, 2000 and entitled “An OFDM Communication Channel”.

### FIELD OF THE INVENTION

This invention relates to DVB-T and OFDM wireless communication channels, and more particularly to improvements in these channels for achieving an interactive bi-directional channel.

All the above applications have been filed by the present inventor.

### BACKGROUND OF THE INVENTION

There is a need for an interactive DVB-T channel, to achieve a broadband return channel. Preferably, such a channel may use OFDM technology.

Advanced communications today may use the Orthogonal Frequency Division Multiplex (OFDM) modulation for efficient transmission of digital signals. These signals may include video, voice and/or data. OFDM is a commonly used implementation of Multi-Carrier Modulation (MCM).

The Orthogonal Frequency Division Multiplex (OFDM) is a modern advanced modulation method, that achieves better use of the frequency spectrum.

OFDM has been used in recent years in many applications where robustness against severe multipath and interference conditions is required, or a high system capacity, flexibility in providing variable bit rate services, scalability and a capability to perform well in Single Frequency Networks (SNF). OFDM forms the basis for various communication standards, including for example the Digital Terrestrial Television Broadcasting, wireless LANs and Wireless Local Loops.

OFDM requires an advanced signal processing.

Thus, a block of information is divided among N frequency channels, so that a portion of the information is transmitted in each of the abovementioned channels or frequencies. Since each channel is orthogonal to the others, a better utilization of the frequency spectrum is achieved.

In OFDM, since each symbol is N times longer, the percent overlap between adjacent symbols decreases, hence the Inter-Symbol Interference ISI is lower. Still better spectrum utilization is achieved by QAM (Quadrature Amplitude Modulation) on each of the N carriers.

An IFFT (Inverse Fourier Transform) is performed on the modulated carriers, to form the signal in the time domain that corresponds to the above modulated carriers. The signal is transmitted as a frame that contains the block of information to be transmitted.

A possible problem in the above modulation scheme may be an error in the time synchronization between signals.

When there is a time synchronization error, the signals after FFT in the various subchannels are rotated with respect to each other.

This effect creates interference within the subchannel.

Another problem is a frequency error between the transmitted signal and the receiver. A frequency error generates a frequency shift that may change the location of symbols and/or may generate interference between symbols.

Because of channel imperfection, a time or phase delay may be generated between the various parts of the spectrum of the transmitted signal. This distortion of the frequency spectrum of the transmitted signal may interfere with the signal reconstruction in the receiver.

The problem is further aggravated by multipath.

Multipath may cause several replicas of a signal to be received, each possibly having a different time delay, amplitude and polarity.

These signals may result in interference between adjacent transmitted frames.

Prior art systems apparently are different.

Thus, Seki et al., U.S. Pat. No. 5,771,224, discloses an orthogonal frequency division multiplexing transmission system and transmitter and receiver therefor. It transmits an OFDM transmission frame, with null symbols and reference symbols being placed in the beginning portion of the frame and QPSK symbols are placed in an information symbol data region in the frame, with equal spacing in time and frequency. The carrier amplitude and phase errors are corrected by a correction information producing section on the amplitude and phase variations of the received signal detected by the variation detector to produce corrected information.

Baum et al., U.S. Pat. No. 5,802,044, discloses a multicarrier reverse link timing synchronization system. A center station transmits a forward link signal, receives a reverse link signal, and determines a timing offset for signals received on a reverse link timing synchronization channel. A reverse link symbol timing synchronization can be used in a system having a plurality of transmitting overlap bandwidth subscriber units on an OFDM-like spectrally overlapping reverse channel.

Gudmundson et al., U.S. Pat. No. 5,790,516, discloses a method and system for pulse shaping for data transmission in an orthogonal frequency division multiplexed (OFDM) system.

Yamauchi, et al., U.S. Pat. No. 5,761,190, discloses an OFDM broadcast wave receiver. An OFDM (Orthogonal Frequency Division Multiplex) broadcast wave receiver for receiving an OFDM broadcast wave.

It automatically discriminates whether the received signal is of a wide band or a narrow band by determining if a carrier signal having a predetermined frequency is present among signals of a plurality of frequencies, acquired by OFDM demodulation of the reception signal by demodulation means.

Schmidl, et al. U.S. Pat. No. 5,732,113, discloses a method for timing and frequency synchronization of OFDM signals. It relates to a method and apparatus that achieves rapid timing synchronization, carrier frequency synchronization, and sampling rate synchronization of a receiver to an orthogonal frequency division multiplexed (OFDM) signal. The method uses two OFDM training symbols to obtain full synchronization in less than two data frames. A first OFDM training symbol has only even-numbered sub-carriers.

A second OFDM training symbol has even-numbered sub-carriers differentially modulated relative to those of the first OFDM training symbol by a predetermined sequence.

Awater, et al. U.S. Pat. No. 5,862,182, discloses an OFDM digital communications system using complementary codes.

The encoding/transmission of information in an OFDM system is enhanced by using complementary codes. The complementary codes, more particularly, are converted into phase vectors and the resulting phase vectors are then used to modulate respective carrier signals. The modulated result is then transmitted to a receiver which decodes the received signals to recover the encoded information.

Isaksson, et al. U.S. Pat. No. 5,812,523, discloses a method and device for synchronization at OFDM-system.

A method of demultiplexing OFDM signals and a receiver for such signals. The method is concerned with synchronization in an OFDM receiver. A signal is read into a synchronization unit, in the time domain, i.e., before Fourier transforming the signal by means of an FFT processor. In the synchronization unit, a frame clock is derived for triggering the start of the FFT process and for controlling the rate at which data is supplied to the FFT processor.

For OFDM reception, it is vital that the FFT process commences at the right point in time. Once the frame clock has been recovered, a frequency error can be estimated by the synchronization unit. The frequency error is used to control an oscillator which generates a complex rotating vector which is, in turn, multiplied with the signal to compensate for frequency errors. The method can be used both with OFDM systems in which symbols are separated by guard spaces, and with OFDM systems in which symbols are pulse shaped.

Kim, U.S. Pat. No. 5,963,592, discloses an adaptive channel equalizer for use in digital communication system utilizing OFDM method. An adaptive channel equalizer for use in OFDM receiver is disclosed. The adaptive channel equalizer comprises a first complex multiplier for outputting a first in-phase complex multiplication signal and a first quadrature phase complex multiplication signal; a reference signal generator for generating a reference signal; an error calculator for outputting an in-phase error signal and a quadrature phase error signal; a delay unit for outputting an in-phase delay signal and a quadrature phase delay signal; a gain controller for outputting an in-phase gain control signal and a quadrature phase gain control signal; a second complex multiplier for outputting a second in-phase complex multiplication signal and a second quadrature phase complex multiplication signal; an adder for outputting updated in-phase and quadrature phase coefficients; an address generator for generating a write address signal and a read address signal; a storage unit for storing the updated in-phase and quadrature phase coefficients, and outputting the updated coefficients; an initial coefficients generator for generating an initial coefficients; a selecting signal generator for generating a selecting signal; and a multiplexing unit for selecting one of the initial coefficients and the updated coefficients according to the selecting signal.

Seki, et al., U.S. Pat. No. 5,694,389, discloses an OFDM transmission/reception system and transmitting/receiving apparatus. The apparatus improves the frequency acquisition range and the resistance to multipath interference. In a digital signal transmission system using OFDM, on the transmission side, some or all of a plurality of equidistant carrier positions are treated as reference carrier positions. The actual transmitted carriers are arranged in a predetermined pattern non-equidistant to the frequency carrier positions to form an OFDM symbol.

The OFDM symbol is periodically transmitted as frequency reference symbols. On the reception side, the carrier arrangement pattern of the frequency reference symbols is detected, a carrier frequency offset is detected from the detected pattern offset, and the carrier frequency is compensated based on the frequency offset.

Cimini, et al. U.S. Pat. No. 5,914,933, discloses a clustered OFDM communication system. A multicarrier communication system for wireless transmission of blocks of data having a plurality of digital data symbols in each block. The communication system includes a device for distributing the digital data symbols in each block over a plurality of clusters, each of the clusters receiving one or more digital data symbols. The digital data symbols are encoded in each of the cluster; and modulated in each cluster to produce a signal capable of being transmitted over the sub-channels associated with each cluster.

A transmitter thereafter transmits the modulated signal over the sub-channels. By distributing the modulated signal over a plurality of clusters, overall peak-to-average power (PAP) ratio is reduced during transmission and transmitter diversity is improved.

Williams, et al. U.S. Pat. No. 5,815,488, discloses a multiple user access method using OFDM. A communication method enables a plurality of remote locations to transmit data to a central location. The remote locations simultaneously share a channel and there is a high degree of immunity to channel impairments. At each remote location, data to be transmitted is coded by translating each group of one or more bits of the data into a transform coefficient associated with a frequency in a particular subset of orthonormal baseband frequencies allocated to each remote location.

The particular subset of orthonormal baseband frequencies allocated to each location is chosen from a set of orthonormal baseband frequencies. At each remote location, an electronic processor performs an inverse orthogonal transform (e.g., an inverse Fourier Transform) on the transform coefficients to obtain a block of time domain data. The time domain data is then modulated on a carrier for transmission to the central location.

Isaksson, U.S. Pat. No. 5,726,973, discloses a method and arrangement for synchronization in OFDM modulation. A method and an arrangement for synchronization in OFDM modulation. Frequency errors of an IF clock and a sampling clock are controlled by estimating the deviation of the sampling clock and, respectively, the IF clock for two subcarriers with different frequencies.

The frequencies are chosen symmetrically around zero and the absolute phase errors are detected for both subcarriers. Timing errors and phase errors are formed from the absolute phase errors in order to generate two control signals. The first control signal is formed from the deviation of the sampling clock and the timing error for controlling the sampling clock while the second control signal is formed from the deviation of the IF clock and the phase error for controlling the IF clock.

Wright, U.S. Pat. No. 5,838,734, discloses means for compensation for local oscillator errors in an OFDM receiver. A receiver for orthogonal frequency division multiplexed signals includes means for calculating the (discrete) Fourier Transform of the received signal, and means for calculating the phase error due to local oscillator errors.

McGibney, U.S. Pat. No. 5,889,759, discloses an OFDM timing and frequency recovery system. A synchronizing apparatus for a differential OFDM receiver that simultaneously adjust the radio frequency and sample clock frequency using a voltage controlled crystal oscillator to generate a common reference frequency. Timing errors are found by constellation rotation. Subcarrier signals are weighted by using complex multiplication to find the phase differentials and then the timing errors. The reference oscillator is adjusted using the timing errors. Slow frequency drift may be compensated using an integral of the timing error. Frequency offset is found using the time required for the timing offset to drift from one value to another.

### SUMMARY OF THE INVENTION

The present disclosure relates to wireless interactive systems and methods. Improvements in a DVB-T channel may achieve a broadband, interactive bi-directional channel.

Preferably, an interactive DVB-T channel with a broadband return channel is implemented, based on full utilization of OFDM technology as the access solution for the return channel.

The DVB-T return channel may provide a proper complementary communication link to the Broadcast link in the same way as it is set in DVB-C, DVB-S and MCNS. Moreover, the wireless solution can provide the service to residential users through a directional antenna or in-home Omni antenna, and equally to provide DVB-T services to nomadic or mobile subscribers, as suitable to various locations worldwide.

Various implementations are possible, for example:

1. GI mode—Use of Guard Intervals (GI) for reception of users messages on the return channel.

2. TDD mode—use of a dedicated channel, apart from the existing broadcast channels. This channel serves the return channel as well as the down link and MAC messages without interference or embedding control messages with the MPEG TS of the broadcast channel.

3. FDD mode—use of a dedicated channel, apart from existing broadcast channels, for the sole purpose of return channel. MAC messages are embedded in the MPEG TS.

4. In-band FDD or TDD mode—use of one or more of broadcast channels serving the return channel on FDD or TDD mode.

Furthermore, improvements in SFN (Single Frequency Networks) are detailed, which may convert broadcast networks to bidirectional networks.

The scope and spirit of the invention may be better understood from the examples of specific applications and implementations, as detailed below.

Further objects, advantages and other features of the present invention will become obvious to those skilled in the art upon reading the disclosure set forth hereinafter.

### BRIEF DESCRIPTION OF THE DRAWINGS

FIG. 1 illustrates an FDD mode bidirectional wireless channel.

FIG. 2 illustrates a TDD mode bidirectional wireless channel.

FIG. 3 illustrates a TDD/FDD mode bidirectional wireless channel.

FIG. 4 details the signals in a TDD mode channel.

FIG. 5 details the subcarriers in an FDD mode channel.

FIG. 6 details the time frame subcarriers in a TDMA channel.

FIG. 7 details the downstream encoding subsystem block diagram.

FIG. 8 details the downstream decoding subsystem block diagram.

FIG. 9 details the DVB-T downstream encoding subsystem block.

FIG. 10 details the DVB-T downstream decoding subsystem block.

FIG. 11 details the upstream OFDM symbol carriers allocation.

FIG. 12 details the downstream OFDM carriers allocation.

FIG. 13 illustrates the interference rejection/avoidance strategy.

FIG. 14 details the RC encoding subsystem block diagram.

FIG. 15 details the RC decoding subsystem block diagram.

FIG. 16 illustrates the downstream BER/SNR with clipping.

FIG. 17 illustrates the upstream BER/SNR with clipping.

FIG. 18 details the spectrum in single carrier OFDM.

FIG. 19 details the DVB-T spectrum.

FIG. 20 details the CNR degradation in SC systems.

FIG. 21 illustrates the phase noise effects in OFDM vs. SC.

FIG. 22 illustrates the BER in OFDM vs. SC.

FIG. 23 details the randomizer schematic diagram.

FIG. 24 illustrates a block diagram of the convolutional encoder.

FIG. 25 details the mother convolutional code rate and puncturing.

FIG. 26 details the PRBS producer schematic diagram.

FIG. 27 details the QPSK mapping and bit pattern.

FIG. 28 details the 16QAM mapping and bit pattern.

FIG. 29 details the 64QAM mapping and bit pattern.

FIG. 30 details the contention PRBS coder producer schematic diagram.

FIG. 31 illustrates the spectral characteristics of FDD.

FIG. 32 illustrates the characteristics of TDD.

FIG. 33 illustrates the characteristics of TDD in a SFN environment.

FIG. 34 illustrates the characteristics of in-band FDD.

FIG. 35 illustrates the conventional coverage with one base station.

FIG. 36 illustrates coverage with a dense deployment of base stations.

FIG. 37 illustrates coverage with an SFN deployment of base stations.

FIG. 38 illustrates rural coverage.

FIG. 39 details the structure of a distributed system.

FIG. 40 illustrates the structure of a broadcasting SFN system.

FIG. 41 illustrates the structure of a broadcasting SFN system with indoors antennas.

FIG. 42 illustrates a local SNF with interactive services.

FIG. 43 details SFN reuse for slow mobility or indoors antenna.

FIG. 44 details a deployment for interactive services for fixed users.

FIG. 45 illustrates the achievable Bit Error Rate (BER) as a function of the Signal to Noise Ratio (SNR).

FIG. 46 illustrates results of a simulation with use of contention pilots.

FIG. 47 illustrates results of a simulation with contention pilots and multipath.

FIG. 48 illustrates a burst structure planning in the frequency domain.

### DETAILED DESCRIPTION OF THE PREFERRED EMBODIMENTS

A preferred embodiment of the present invention will now be described by way of example and with reference to the accompanying drawings.

### Abbreviations

Throughout the present disclosure, the following abbreviations may be used:

### ASC—Automatic Synchronization Control

### APC—Automatic Power Control

### BER—Bit Error Ratio

### BS—Base Station

### CBR—Constant Bit Rate

### DDS—Direct Digital Synthesizer

### DQPSK—Differential Quadrature Phase Shift Keying

### DVB—Digital Video Broadcasting

### DVB-T Digital Video Broadcasting Terrestrial

### FAU—Far Access Unit

### FDD—Frequency Division Multiplex

### FFT—Fast Fourier Transform

### IFFT—Inverse Fast Fourier Transform

### MAC—Media Access Control

### MPEG—Moving Picture Expert Group

### OFDM—Orthogonal Frequency Division Multiplexing

### OFDMA—Orthogonal Frequency Division Multiple Access

### PRBS—Pseudo Random Binary Sequence

### QAM—Quadrature Amplitude Modulation

### QPSK—Quadrature Phase Shift Keying

### RF—Radio Frequency

### RS Reed-Solomon

### SFN—Single Frequency Network

### SNR—Signal to Noise Ratio

### TDD—Time Division Multiplex

### TDMA—Time Division Multiple Access

Digital Video Broadcasting [symbol] Terrestrial (DVB-T) using COFDMA technology has been proven as a good solution for terrestrial broadcasting in many tests and comparisons around the world (even in mobility test, tested in Singapore). A Return Channel (RC) for the DVB-T is a must in order to deliver interactive services, Return Channels for cables have been defined already (DVB-RCC and DOCSIS) where data transmission of IP packets and ATM cells for telephony, data and in the future video services will be supplied.

According to one embodiment of the invention, there is disclosed a system that can provide Broad Band solution for fixed and mobile users and that can compete with satellite and cable solutions existing today, with the distinct differentiation of mobility. Such a system has to be designed for good survivability, therefore the novel approach includes adaptive modulations, coding and data rates in the overall solution.

Following is a description of systems using TDD or FDD duplexing techniques, with details relating to the physical layer and the principles of the MAC layer for the FDD system. In order to leverage existing technology and reduce costs, the novel approach uses many of the DVB-T standard aspects in both the Down Stream channel (Base Station to Subscriber Unit) and the Up stream (Subscriber Unit to Base Station).

### Duplexing Technique

The novel physical layer is based on Frequency Division Duplexing (FDD), which provides a separate frequency assignment for the up stream and down stream channels (where for the down stream a DVB-T transmission could be used while in the up stream an OFDMA/TDMA modulation/access method is used).

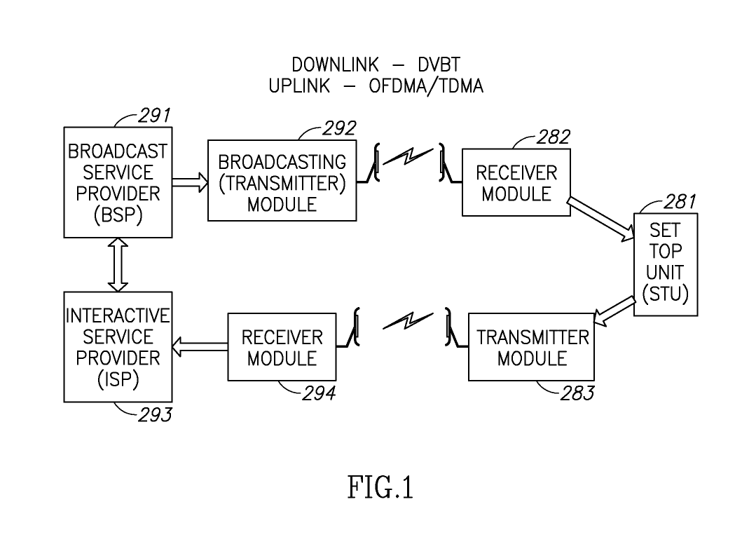

A modification of the OFDM modulation parameters may be used to operate the system in Time Division Duplexing (TDD) or in a combined TDD/FDD mode. Possible system architectures for the above mentioned operating modes are described in FIGS. 1 to 3.

FIG. 1 illustrates an FDD mode bidirectional wireless channel. A broadcast services provider 291 is connected to a broadcasting (transmitter) module 292 and an interactive services provider 293, as well as a receiver module 294. This allows for a bidirectional channel with a user having a set top unit (STU) 281 connected to a receiver module 282 and a transmitter module 283 as illustrated.

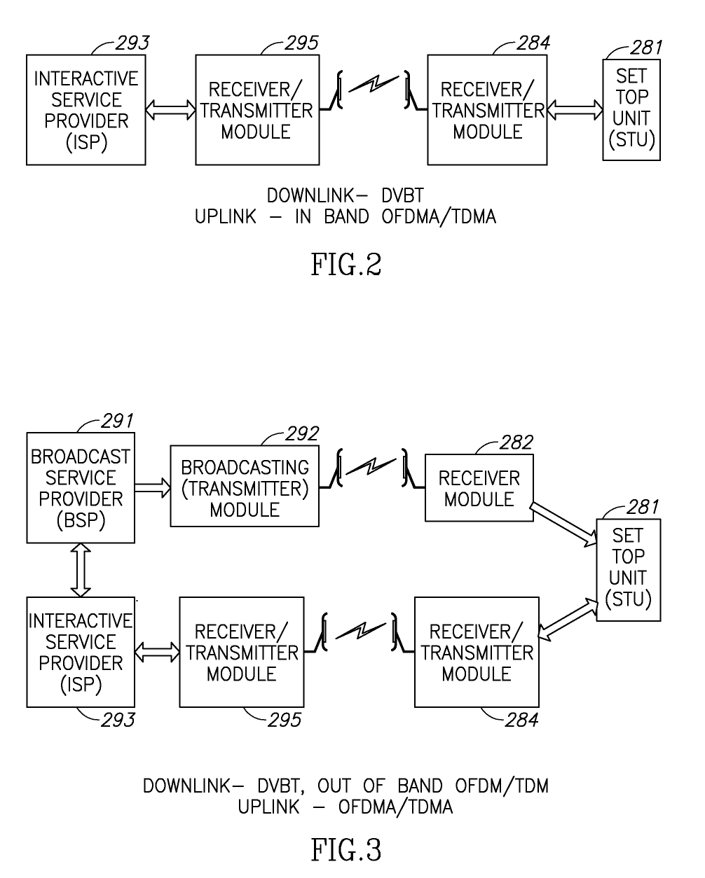

FIG. 2 illustrates a TDD mode bidirectional wireless channel. Here, an interactive services provider 293 is connected to a receiver/transmitter module 295, which connects to a user.

The user's equipment includes a set top unit (STU) 281 connected to a receiver/transmitter module 284.

FIG. 3 illustrates a TDD/FDD mode bidirectional wireless channel.

A broadcast services provider 291 activates a broadcasting (transmitter) module 292 and an interactive services provider 293 which is connected to a receiver/transmitter module 295.

The user's equipment includes a set top unit (STU) 281, which is connected to a receiver module 282 and a receiver/transmitter module 284.

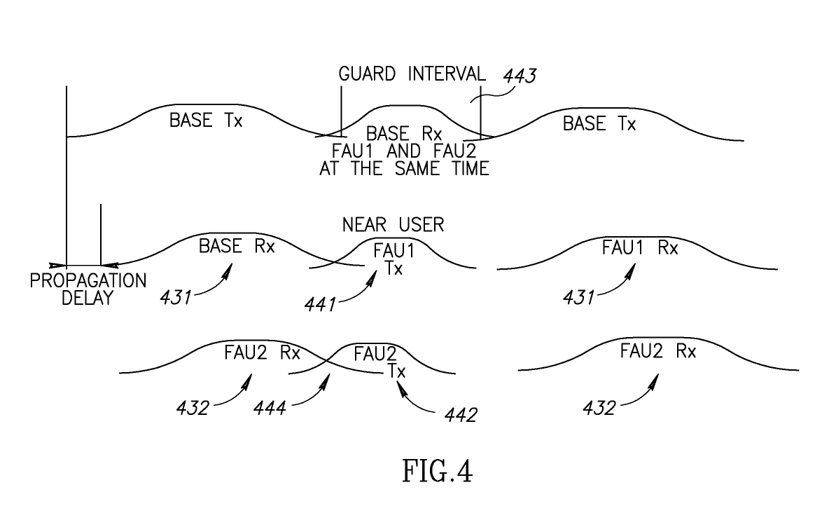

The TDD mode uses shaping of the Transmitted signal (both Up Stream and Down Stream) in order to use as much time as possible for the transmission of the up link (see FIG. 4).

FIG. 4 details the signals in a TDD mode channel.

A base transmit period comprises a transmit period, a receive period and an guard interval, as illustrated. That is, it includes guard interval 443, base is receiving, FAUs transmit; FAU1 receive period 431; FAU1 transmit period 441; FAU2 receive period 432; FAU2 transmit period 442 and overlap time 444.

The FDD mode uses one frequency for down stream (using the DVB-T standard) and another frequency for the up stream (using OFDMA/TDMA) see FIG. 5.

FIG. 5 details the subcarriers in an FDD mode channel in the frequency domain, with frequency axis 12. The spectrum of data 131, 132, 133 and the corresponding pilots 141, 142, 143, are illustrated.

In a preferred embodiment, the transmitted signal includes pilots of equal amplitude and being in phase. Furthermore, the pilots are equidistant in the frequency domain.

In the upper part of FIG. 5, the downlink uses DVB-T, whereas in the lower part of FIG. 5, the downlink uses OFDM/TDM.

### Multiple Access Method

The novel upstream physical layer is based on the use of a combination of Time Division Multiple Access (TDMA) and Orthogonal Frequency Division Multiple Access (OFDMA). In particular, the upstream is divided into a number of “time slots” as defined by the MAC layer. Each time slot (sized to duration of one OFDM symbol) is then divided in the frequency domain into groups of sub-carriers referred to as subchannels. The MAC layer controls the assignment of subchannels and time slots (by bandwidth on demand and Data Rate on demand).

The description focuses on the efficient transport of ATM cells and IP packets in the upstream and down stream channels. In the FDD mode the Up Stream time frame includes 16 OFDM symbols (17 Up Stream time frames are included in one DVB-T Super Frame), each OFDM symbol can include up to 16 users (which gives a total of 256 slots allocations in each time frame).

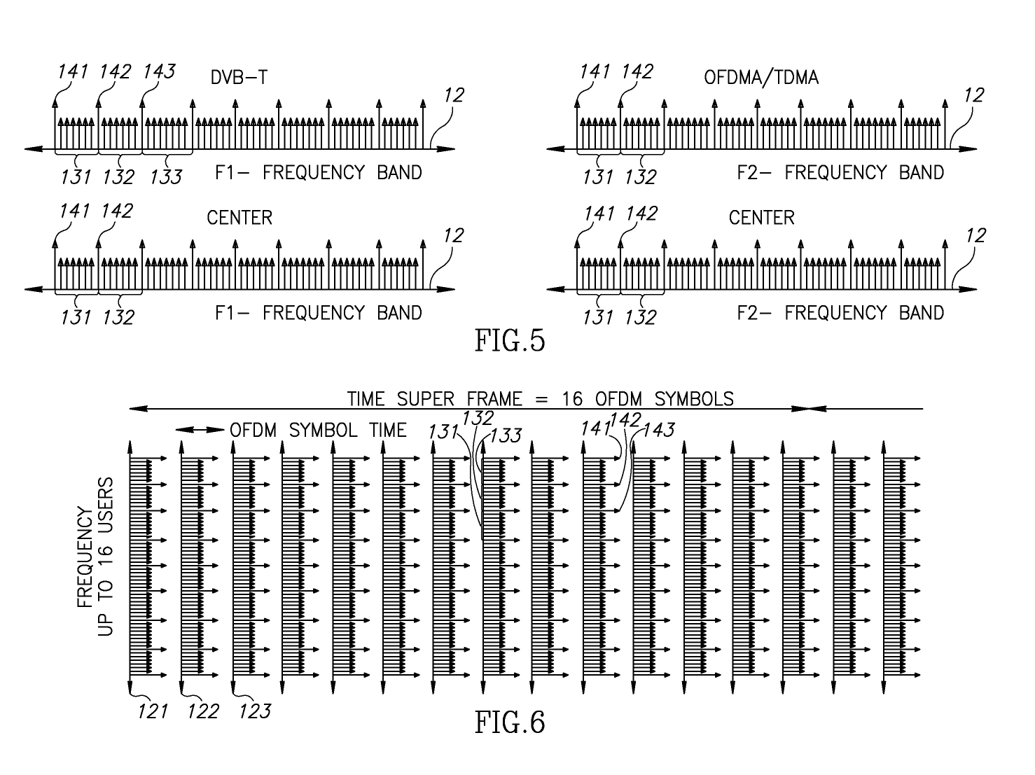

FIG. 6 details the time frame subcarriers in a TDMA channel. in the time/frequency domain, the frequency axes 121, 122, 123, etc. The signals comprises the spectrum of data 131, 132, 133 and the pilots 141, 142, 143.

### DownStream Physical Layer

The downstream physical layer uses the well-proven DVB-T physical layer. This standard uses the OFDM as its modulation technique and transports packetized digital video corresponding to MPEG-2. A larger concept of the down stream can include the following—An OFDM symbol will be divided (in the frequency domain) into groups. The first group is a group, which will be dedicated for the broadcast of MPEG-2 transport and can be used in a SFN as the broadcasting area. The MAC layer for fast feedback or response will use another group, the last group will be allocated for dedicated channels and could carry different information in a SFN configuration.

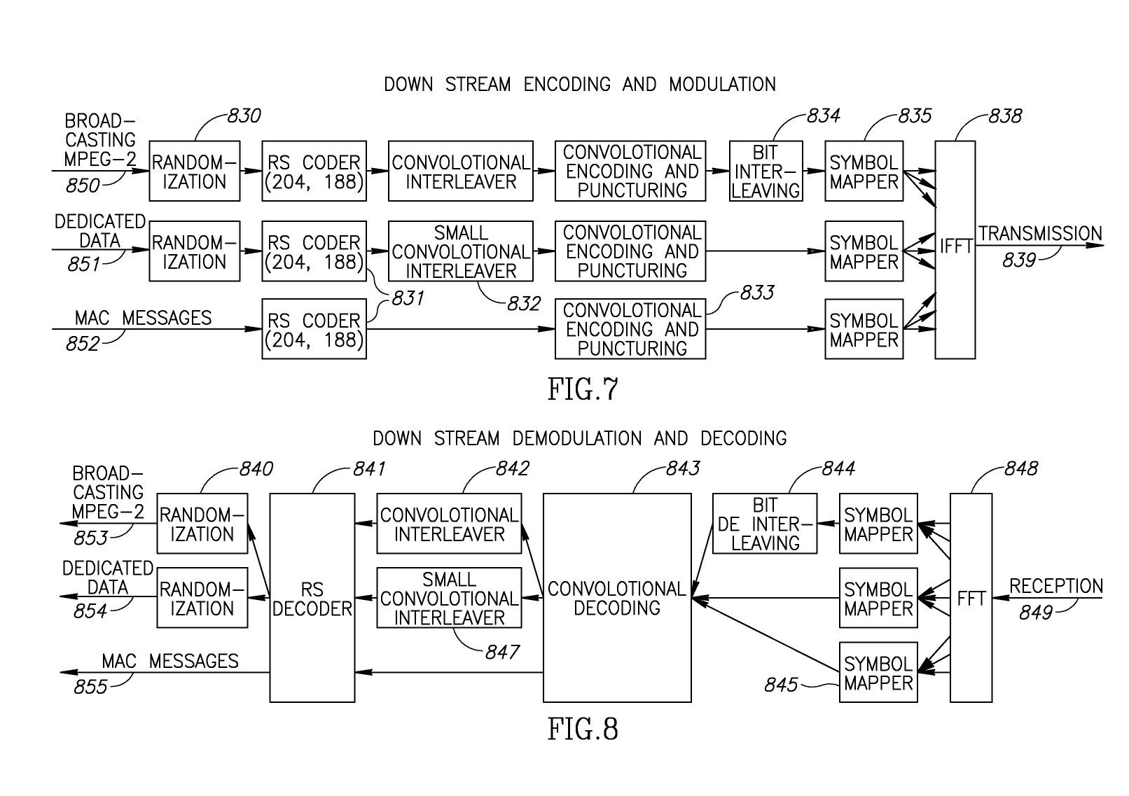

The broadcasting subcarriers group shall vary as needed, if there is no need for any broadcasting all of its subcarriers group shall be used by the dedicated channels. The encoding and decoding functions for the different group types are summarized in the next block diagram, the functions for the MPEG-2 data stream and for the dedicated channels are adopted from the DVB-T standard (FIGS. 7 and 8).

FIG. 7 details the downstream encoding subsystem block diagram. The subsystem may be used for several channels, for example one for broadcasting MPEG-2 850, another for dedicated data like MPEG-2 851, and one for MAC messages 852. Each channel is processed in a randomization unit 830, RS coder 831, for example (204,188), convolutional interleaver 832, convolutional encoding and puncturing unit 833, bit interleaver 834, symbol mapper 835.

The several channels as illustrated are then processed in the IFFT unit 838

Note: various embodiments of the invention may be implemented.

For example, an RS coder (26,20) may be used, as illustrated. Similarly, a small convolutional interleaver may be used.

FIG. 8 details the downstream decoding subsystem block diagram.

The system includes a reception signal 849 which is transferred to FFT unit 848, followed by symbol demapper 845, bit deinterleaver 844, convolutional decoding unit 843, convolutional interleaver 842, RS decoder 841 and randomization unit 840.

The result is transferred to output the data in several channels as sent, for example one for broadcasting MPEG-2 853, another for dedicated MPEG-2 854, and one for MAC messages 855.

A small convolutional interleaver 847 may be used as well.

The transport stream is therefor very robust and can be changed as a function of the protection against fading, noise and distance that should be reached for every dedicated channel. Use of various modulation schemes (QPSK, 16QAM, 64QAM) and different puncturing rate ½, ⅔, ¾, ⅚, ⅞ enables an optimization of the Downstream bit rate and protection for every dedicated channel.

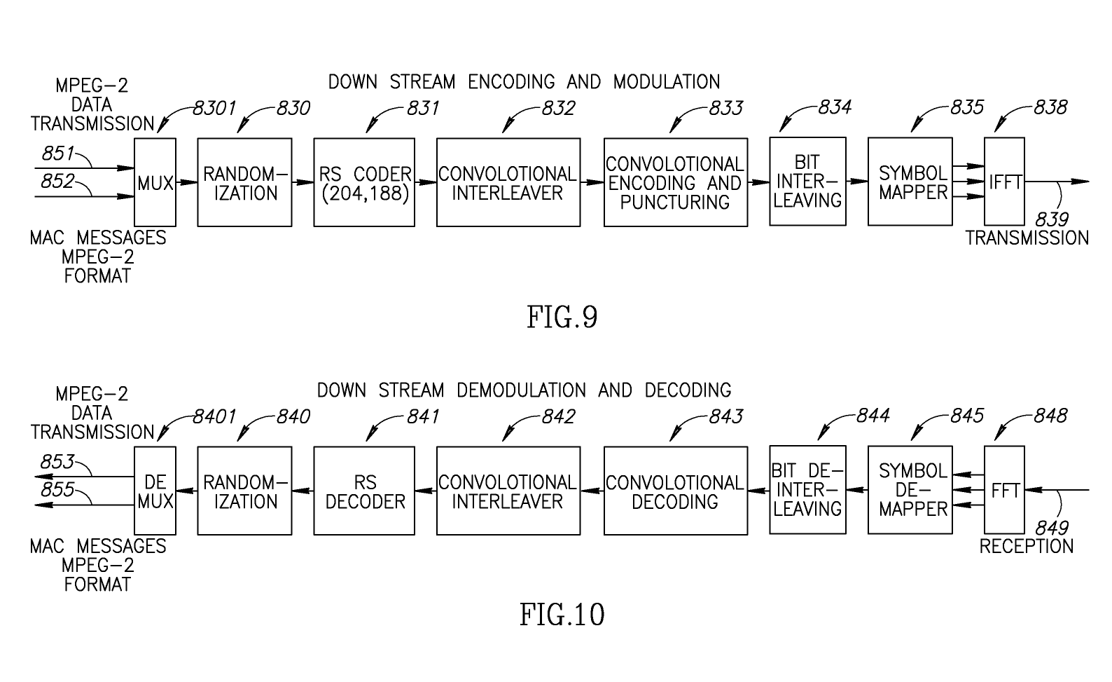

This downstream concept can be simplified so it will become the DVB-T standard, by using the carriers for broadcasting and embedding the MAC messages into the MPEG-2 stream, see FIGS. 9 and 10.

FIG. 9 details the DVB-T downstream encoding subsystem block. The input may include MPEG-2 data 851, and one for MAC messages 852. Each channel is processed in a MUX 8301, randomization unit 830, RS coder (204,188) 831, convolutional interleaver 832, convolutional encoding and puncturing unit 833, bit interleaver 834 and symbol mapper 835.

The resulting signal is processed in IFFT unit 838 and is transferred to the channel for transmission 839.

FIG. 10 details the DVB-T downstream decoding subsystem block. The reception signal 849 is processed in FFT unit 848, followed by symbol demapper 845, bit deinterleaver 844, convolutional decoding unit 843, convolutional interleaver 842, RS decoder 841, randomization unit 840 and DeMux 8401.

The outputs include one channel for MPEG-2 data transmission 853, another for MAC messages 855.

### Up Stream Physical Layer

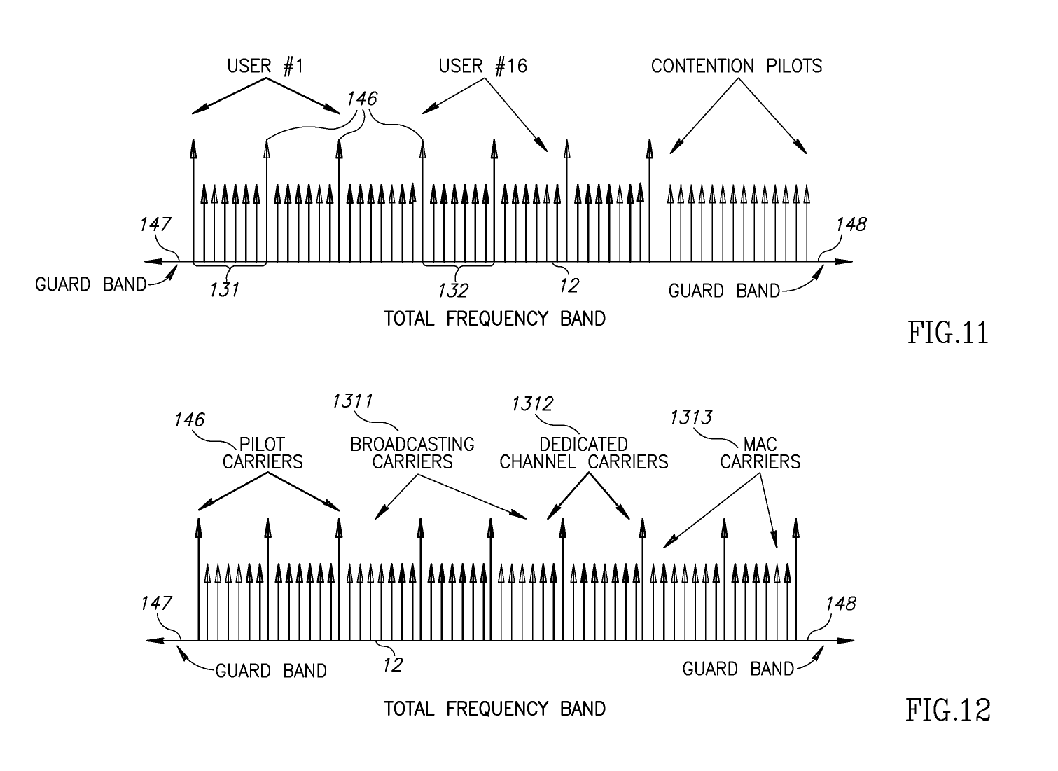

The upstream physical layer is also based upon OFDM modulation and includes two types of carriers. The first are groups of carriers (Sub-Channels) which are used for Subscriber-Units data transmission, the other includes several carriers (Contention carriers) which are used for synchronization of new Subscriber-Units which need bandwidth allocation (see FIG. 11). The maximum number of Subscriber Units, which Sub-Channels are allocated to in one OFDM Symbol, is 16.

While on the Contention area 32 new Users can transmit simultaneously by using CDMA technique (most likely that only few new Subscriber-Units will join at the same OFDM symbol), and allocating pseudo random codes to each user (by the MAC layer). At the Base Station those new Subscriber units are synchronized using Automatic Synchronization Control (ASC) and power controlled by Automatic Power Control (APC), and then they are allocated Sub-Channels in a specified OFDM Symbol by the MAC layer.

FIG. 11 details the upstream OFDM symbol carriers allocation.

The description is in the frequency domain, with frequency axis 12. The spectrum of data 131 for User #1 and data 132 for User #16 include, for example contention pilots 146 and guard bands 147 and 148.

The number of subchannels allocated to a specific user and the timing they will be transmitted in a specified time frame are controlled also by the MAC layer. Since the upstream is TDMA/OFDMA based, the channel can be modeled as a continuous sequence of “time slots” and each time slot can be modeled as a group of subchannels that are allocated to different Subscriber Units by Bandwidth on Demand. By using this technique, QoS requirements and bandwidth requirements can be managed.

Every working Subscriber-Unit can be allocated several Sub-Channels, one Sub-Channel per Subscriber-Unit is also used for pilot allocation, and each Subscriber Unit can be allocated a different number of pilots (11,21,51,101) in order to mitigate multipath effects. The rest of the carriers are used for data transmission, were each user sends data modulated by adaptive modulation (QPSK, 16QAM or 64QAM), the MAC layer controls the modulation of each Subscriber-Unit and coding scheme used, in order to supply each user its demands for data rate, BER, and QoS.

FIG. 12 details the downstream OFDM carriers allocation in the frequency domain, with frequency axis 12, guard bands 147 and 148, pilot carriers 146, broadcasting carriers 1311, dedicated channel carriers 1312, MAC carriers 1313

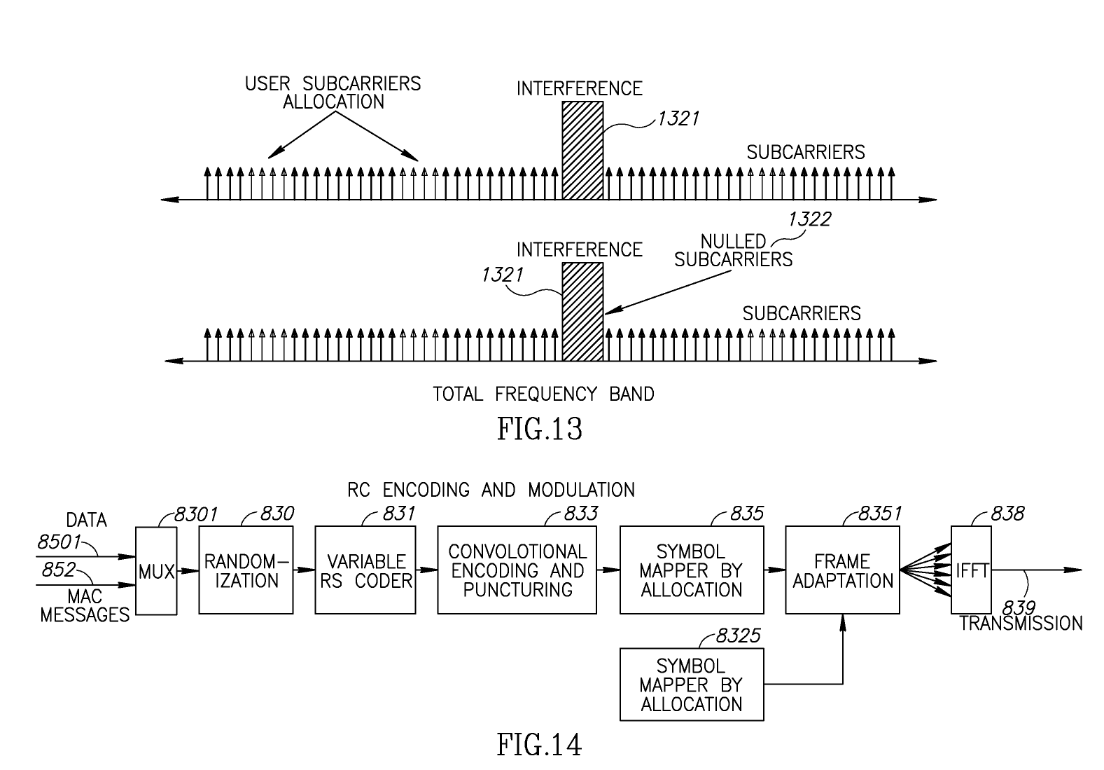

FIG. 13 illustrates the interference rejection/avoidance strategy. There are user subcarriers allocation 1320. When an interference 1321 is detected, the system reacts with nulled subcarriers 1322, to counter the interference.

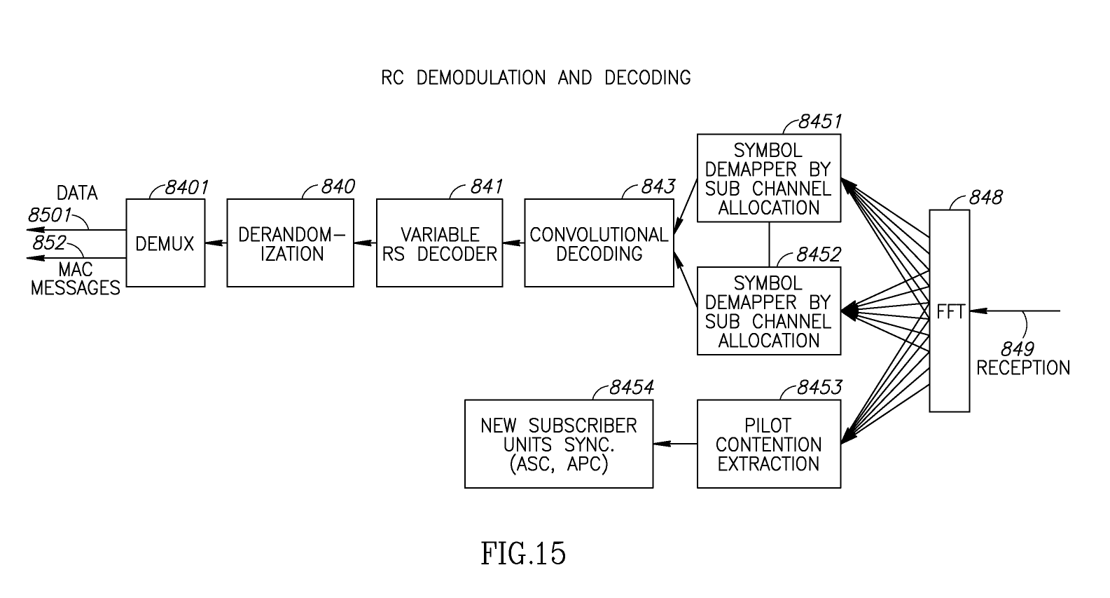

The recommended coding and modulation of upstream packets are summarized in the block diagram shown in FIGS. 14 and 15. As shown in the diagram such a coding scheme is used in order to support a large granularity for the bandwidth on demand requirements. While the variable Reed Solomon Coder (systematic RS(31,23) with variable erasures) and the Punctured Convolutional encoding enables a degree of freedom in order to supply to a Subscriber-Unit its demands for a certain BER.

FIG. 14 details the RC encoding subsystem block diagram.

The transmit data, may include for example a data channel 8501 and MAC messages 852. Each channel is processed in a MUX 8301, randomization unit 830, variable RS coder (204,188) 831, convolutional encoding and puncturing 833, symbol mapper by allocation 835, frame adaptation 8351, contention code producer 8352 and IFFT unit 838, for transmission 839.

FIG. 15 details the RC decoding subsystem block diagram.

The reception signal 849 is processed in FFT unit 848, symbol demapper by suballocation units 8451 and 8452, convolutional decoding unit 843, RS decoder 841, de-randomization unit 840, DeMux 8401.

The outputs may include a data channel 8501 and MAC messages 852. The system further includes a pilot contention/extraction unit 8453 and new subscriber units synchronization 8454, including ASC and APC.

### Physical Layer Properties

The following description deals with various aspects of the physical layer implementation.

1. Synchronization Technique/Timing Control

In order to avoid highly accurate frequency source (e.g., OCXO) at the Subscriber Unit and satisfy timing requirements for telephony or other CBR applications (T1/E1), it is highly efficient to derive the Subscriber Unites clocks from the Down Stream transmission. This can be achieved by using the Pilots carriers transmitted by the Base Station, these Pilots can also be used in order to Synchronize onto the Down Stream transmission and achieve clock extraction. Accurate up stream time slot synchronization shall be supported through a ranging calibration procedure defined by the MAC layer using the pilots transmitted by each Subscriber Unit, moreover the Base Station copes with users transmission not arriving fully synchronized, and relieving the demand of precise user's synchronization.

To that purpose, a cyclic prefix may be added, wherein the prefix is the data transmitted at the end of a time interval.

The addition of that prefix reduces the sensitivity to timing errors in the time of arrival (TOA) to the extent of the guard interval (GI) value.

### 2. Frequency Control

The clock extracted from the Down Stream (as detailed elsewhere in the present disclosure) is used as the reference clock of the Subscriber unit, in particular to produce the RF frequency for the transmission and to adopt this clock as the Subscriber Unit Base Band clock. Locking on the Down Stream transmission frequency shall allow an accurate Upstream RF transmission frequency to be produced, which ensures that all Subscriber Units transmitting shall reach the Base Station Orthogonal, keeping the OFDM properties.

### 3. Power Control

In order to perform an Up Stream power control the Base Station may use a calibration and a periodic adjustment procedure. The adjustment values may be sent to a Specific Subscriber Unit via the MAC layer. The Base station may extract the adjustment values by monitoring the power on the carriers that were allocated to the specified Subscriber Unit on the specified OFDM symbol.

If using on the Down Stream the full concept of an OFDM/TDM then controlling the power of the Down Stream dedicated channels shall perform another power control mechanism. The specified Subscriber Unit MAC shall send adjustment values to the base station correcting the power transmitted on the dedicated channel, and adjusting it to the demands of a certain SNR. This procedure will enable an optimized use of the base station Power Amplifier.

### 4. Crest Factor

Much research has been done on the crest factor of OFDM modulation. Although the maximum crest factor is derived by, where N is the number of carriers used in the OFDM symbol. Taking into consideration that in our suggested system we use a 2048 carriers FFT/IFFT which is very similar to the 2 k mode of the DVB-T we shall introduce some measurements done on the DVB-T.

In the DVB-T, 1705 carriers are used for carriers transmission, a crest factor of 32.3 dB would be expected but in fact only 9-9.5 dB crest factor (with peaks of 10.5 dB) is actually measured in any modulation using QPSK, 16QAM and 64QAM. These results are achieved by the randomization of the data sent on the carriers.

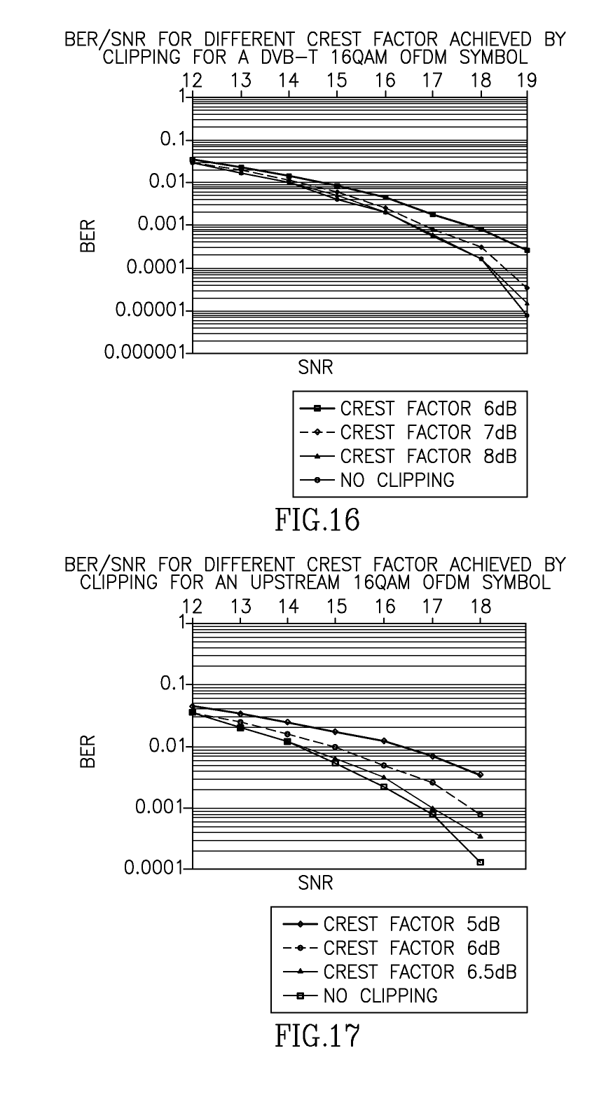

For the Upstream where a reduced number of carriers are used (taking into consideration that all useful carriers are divided into 16 subchannels), the crest factor achieved is about 7-7.5 dB for QPSK, 16QAM and 64 QAM all modulations (with peaks of 9.5 dB); Also by using Clipping techniques we can reduce the crest factor in such a way that the crest factor will go down to 6.5 dB while introducing only about 0.2-0.4 dB degradation (FIGS. 16, 17).

By using more sophisticated methods, more reduction can be achieved.

FIGS. 16, 17: BER/SNR for different Crest Factor achieved by clipping for A Upstream 16QAM OFDM Symbol

FIG. 16 illustrates the downstream BER/SNR with clipping.

FIG. 17 illustrates the upstream BER/SNR with clipping.

### 5. Power Amplifier Efficiency

As detailed above in sections 3 and 4, for high modulation scheme the crest factor of an OFDM transmission can be achieved to be even lower then for single carrier transmission. Furthermore considering the spectrum efficiency of the OFDM modulation we can derive that the power amplifier usage for an OFDM transmission is very high, and a power control mechanism allows the better usage of the Power Amplifier.

In particular, these conclusions are enhanced for an Uplink transmission, while for a Single Carrier transmission the same power efficiency is achieved.

For an OFDM transmission, where the user is allocated a subchannel the total power transmitted is divided between less carriers, gaining an additional 12 dB of power (for a case were the symbol is divided for 16 users).

6. Timing sensitivity

In an OFDM modulation, there is no timing sensitivity within the sample time and simple phase and channel estimators correct inaccuracies. Furthermore, the Guard Interval of the transmissions insures immunity in the face of multipath or unsynchronized reception of OFDM transmission from several sources. In particular this fact enables the creation of SFN on the Down Stream, and of a very relaxed timing synchronization demands of Subscriber Units in the Uplink.

### 7. Frequency Sensitivity

OFDM symbol demodulation is sensitive to frequency inaccuracies. This sensitivity is solved by accurate AFC loops using DDS. Using the above approach all Subscriber Units lock on the Base Station frequency as explained in section 2 above. In doing so they ensure that their own transmission is kept orthogonal to other Subscribers, and the total OFDM symbol shall remain orthogonal.

### 8. Group Delay

The same channel estimators mentioned in section 7 can compensate group Delay caused by filters. The Group Delay introduced is treated like a channel imparity.

### 9. Burst Efficiency

Upstream bursts of Subscriber Unit are very efficient because of a low overhead. Subscriber Unit that has been allocated to one subchannel can have only 11% (11 of 101 carriers) of the carriers dedicated to pilots (these are used for all receiver demands for time, power and frequency control, and are also used for channel estimation). If user is allocated more subchannels there is no need for further increase of pilots number, so for 2 subchannel efficiency shall rise and the overhead decreases to 5.5% (11 of 202 carriers), if all band is given to the user the overhead shall be less than 1%. The number of carriers allocates to a Subscriber Unit can vary (so effecting the burst efficiency) to 11,21,51,101 carriers.

### 10. Coherent Detection

The Upstream and Downstream are corrected by channel estimators and then coherently detected, the coherent detection for QPSK is more then 1.7 dB better in performance the differential detection for DQPSK. Improved performance is achieved for higher modulation schemes.

Following are some examples of technical specifications achievable in an FDD system, where for the Down Stream the DVB-T standard is used and in the Up Stream the OFDMA/TDMA approach is used. We shall present the technical specification of the Up Stream.

1. The Functional Block Diagram as illustrated in FIG. 14, is a conceptual scheme of the RC Encoding and Modulation for an already working Subscriber Unit and for a new Subscriber Unit which needs services. In the figure we can observe the different mechanisms which are involved in the Up Stream Modulation and Encoding. The next procedure is performed at each Subscriber Unit already working and that has been allocated a transmission Sub-Channels, these parameters are defined by the MAC layer.

The Data from a Unit is first randomized by a variable randomization procedure (which depends on the packet length to transmit in the specified OFDM Symbol), then it is encoded by a variable Reed Solomon Coder and a punctured convolutional coding. The symbol mapper which uses adaptive QAM modulations maps the data stream, and the Frame Adaptation mechanism maps those into the Subscriber Unit allocated data carriers. The Frame Adaptation is also responsible for the pilot [symbol] s insertion for working Subscriber Units and on contention pilots insertion for new Subscriber Units.

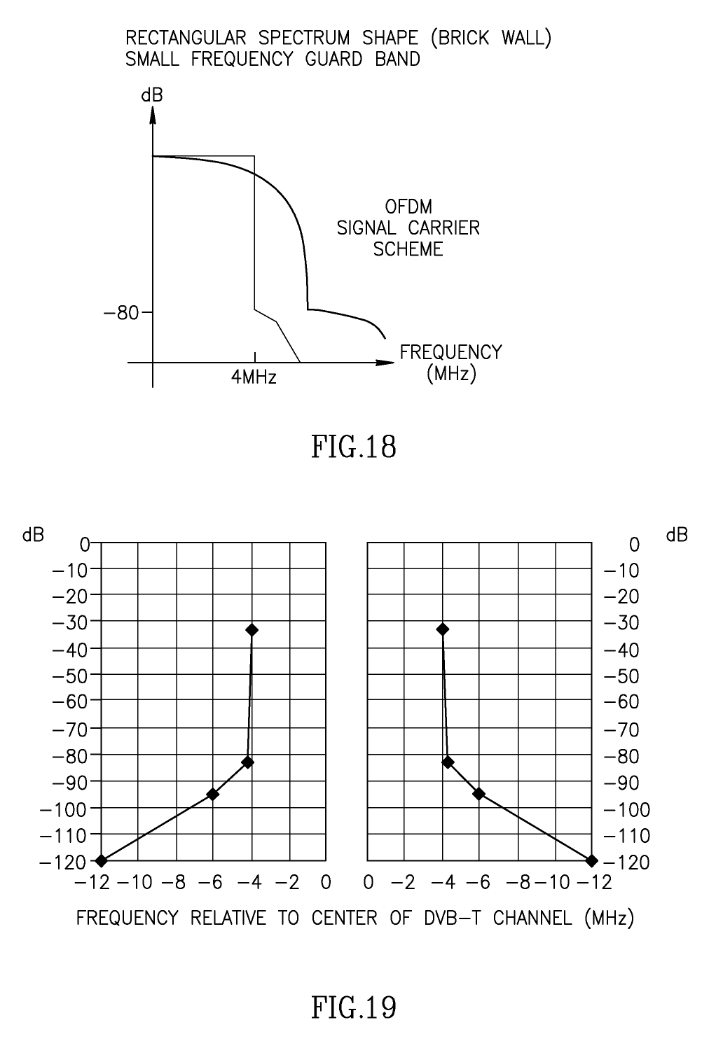

FIG. 18 details the spectrum in single carrier OFDM.

FIG. 19 details the DVB-T spectrum.

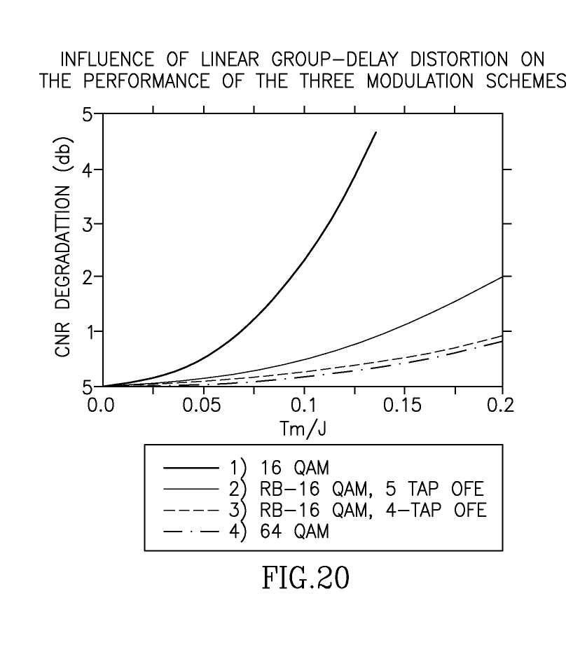

FIG. 20 details the CNR degradation in SC systems.

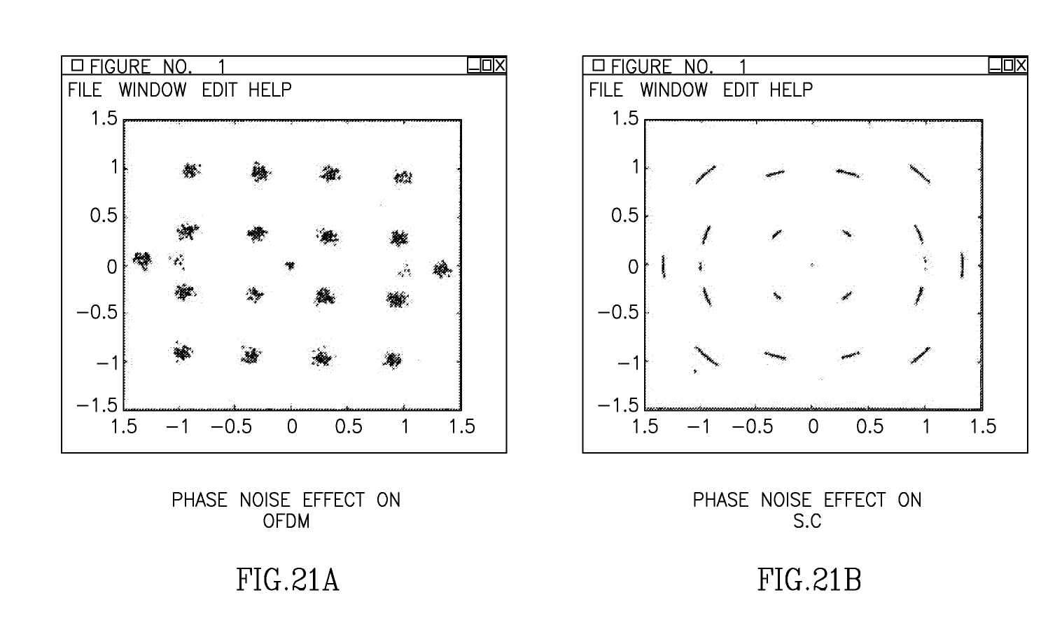

FIG. 21 illustrates the phase noise effects in OFDM vs. SC.

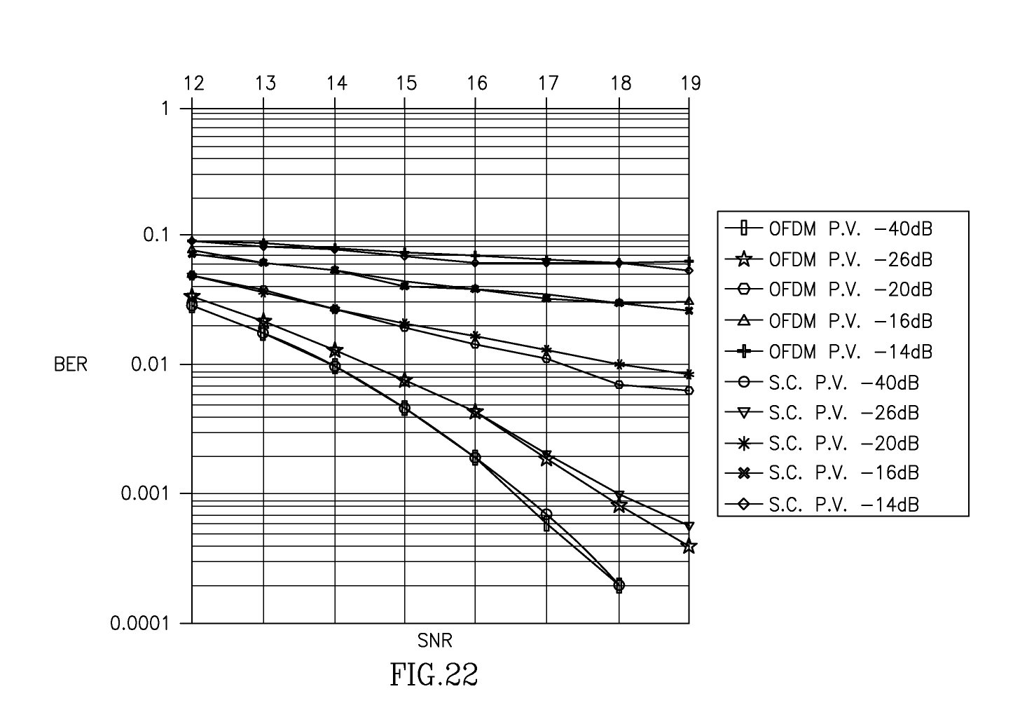

FIG. 22 illustrates the BER in OFDM vs. SC

### 2. Randomization

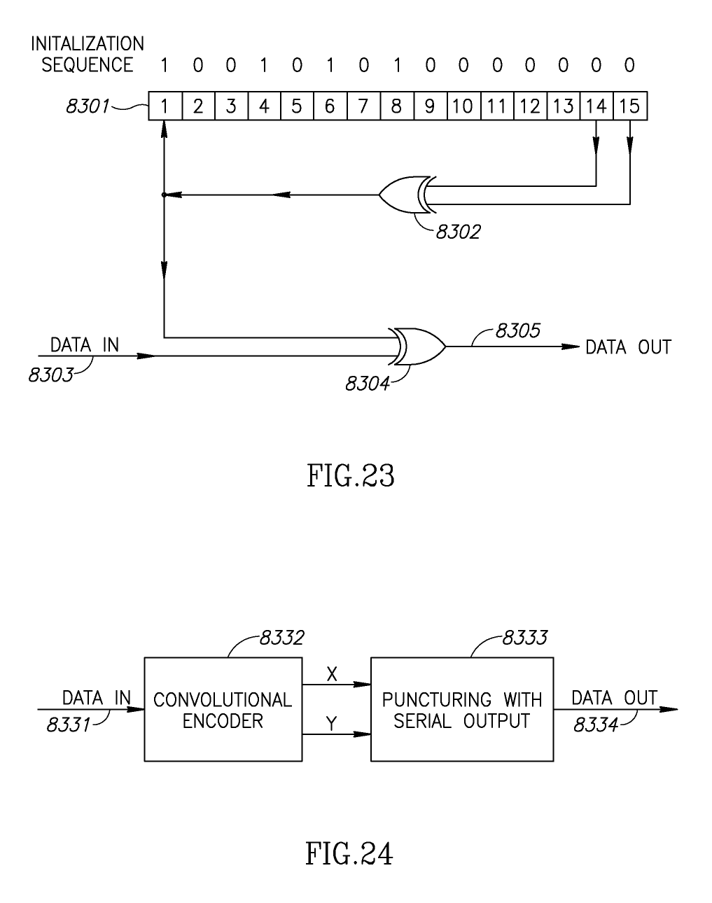

Data entering the randomization mechanism is first muxed from Subscriber Units Data and MAC messages, this is controlled by the MAC layer. FIG. 23 is a schematic diagram of the randomization procedure, this randomizer is initialized for each new OFDM Symbol transmitted.

FIG. 23 details the randomizer schematic diagram.

It includes a shift register means 8301, a first XOR gate 8302 receives outputs 14 and 15 from shift register 8301 and feds the XOR product back to the input of the shift register to generate a pseudo-random sequence.

The shift register has to be initialized to a specific state to generate the desired sequence.

The output of gate 8302 also serves to randomize the data input 8303, using a second XOR gate 8304, to generate the randomized data output 8305.

The polynomial for the Pseudo Random Binary Sequence (PRBS) generator shall be, and the first bit at the output of the PRBS shell be applied to the first data bit to be transmitted in this OFDM symbol.

### 3. Reed Solomon Coding

The Reed Solomon code used for the encoding is the systematic RS(31,23,t=4). This is a Code generator polynomial.

The coding produced could be varied by the number of protection groups (5 bit to each group) sent, the maximum protection of this RS code is 8 groups while smaller protection groups can be used (using erasures at the receiver side). Also a shortened code can be produced by first zero padding the data before encoding, the zero padding length is depended by the amount of data to be sent on the OFDM symbol.

### 4. Convolutional Encoding

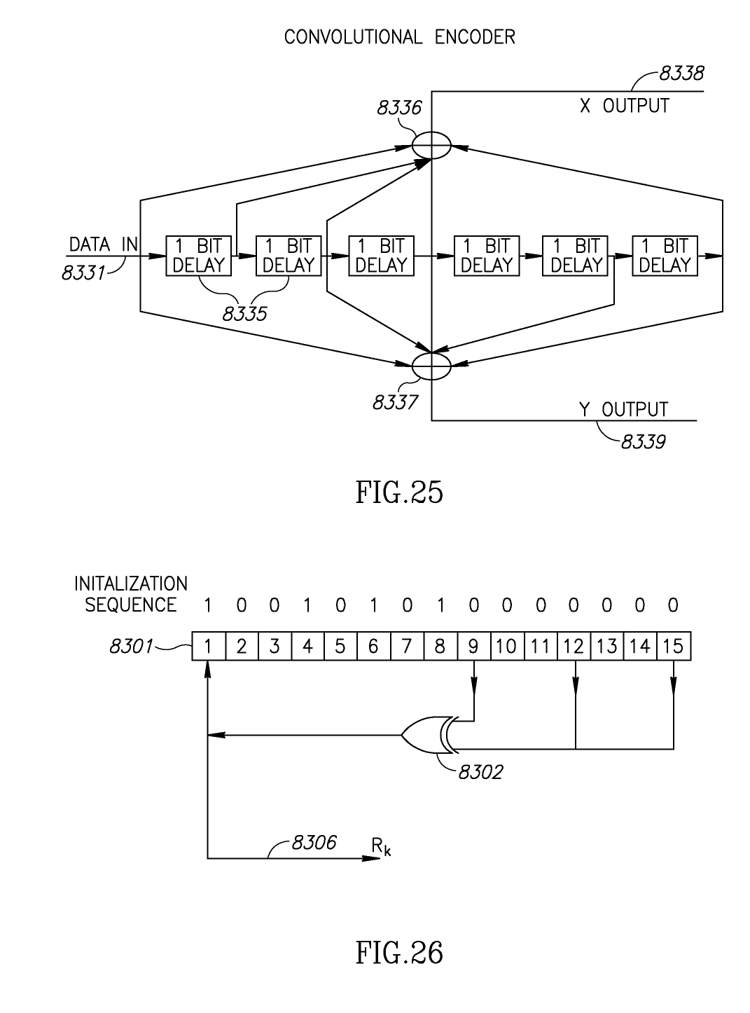

The Convolutional encoding shell be based on the mother code of For X For Y, See FIGS. 24 and 25.

A puncturing scheme shell be used, with a code rate of ¾, the puncturing pattern is:

Code Rate Puncturing Pattern Transmitted Sequence (after parallel to serial conversion)

### X: 1 0 1 Y: 1 1 0

FIG. 24 illustrates a block diagram of the convolutional encoder.

The data input 8331 is connected to a convolutional encoder 8332, with X and Y inputs processed in the puncturing unit 8333, with serial output data output 8334.

FIG. 25 details the mother convolutional encoding and puncturing unit

The data input 8331 is transferred to one bit delay means 8335, with logic means 8336 and 8337 to process the delayed bits.

The results are the X output 8338 and the Y output 8339.

### 5. Contention Code Producer

The contention pilots are used for synchronizing new Subscriber Units that need services. Any Subscriber Unit which wants to communicate with the base station draws a code number (0-31) and produces a Pseudo Random Sequence which is then used for the transmission of the contention pilots. The PRBS which produces all the codes is described in FIG. 26. The polynomial generator shall be.

FIG. 26 details the PRBS producer schematic diagram. The system includes a XOR gate 8302 receives outputs 9, 12 and 15 from shift register 8301 and feds the XOR product back to the input of the shift register to generate a pseudo-random sequence.

The sequence thus generated is output as signal Rk at output 8306

The shift register has to be initialized to a specific state, as indicated in the figure, to generate the desired sequence.

There are 101 pilots for the contention pilots, each code contains 101 bits which are transmitted on those 101 contention pilots. The 32 codes defined in the system can be produced by the PRBS sequentially from its initialization. The first 101 bits produced are defined as code #0, the next 101 bits are defined as code #1 and so on until code #31. The contention pilots modulation is given by:

Where j denotes the code #, i denotes the index of the pilot within the code, and R denotes the PRBS output at the specified index.

### 6. Sub-Channels Carriers Location

An OFDM symbol contains 2048 carriers, from which only 1717 are used. These 1717 (numbered 0 to 1716) carriers are divided into 16 Data Sub-Channels and one Contention Sub-Channel. Each Sub-Channel carrier location within those 1717 carriers is defined by:

Sub-Channels 0.15 are Data Sub-Channels while Sub-Channel 16 is the Contention Sub-Channel.

### 7. Pilots and Data Allocation on Sub-Channels

An active Subscriber-Unit can be allocated several Data Sub-Channels or even all the Data Sub-Channels. Within those carriers Sub-Channels a Subscriber-Unit sends its data and it also sends pilot carriers (the index of the carriers on a Data Sub-Channel is from 0 to 100). The number of pilot carriers a Subscriber-Unit is ordered to send can vary between 11,21,51,101 pilots.

The next table defines the pilot [symbol] s location within a Data Sub-Channel:

Number of Pilots Pilots index within the Sub-Channel 11

Each Subscriber-Unit allocates the pilots only on one Sub-Channel which is the lowest Sub-Channel it was allocated, for example a Subscriber-Unit that has been allocated Sub-Channels Number 3,9,12,15 shell allocate the necessary pilots on Sub-channel #3.

Each Subscriber-Unit allocates its data on the following carriers: ? On the lowest Sub-Channel (after pilot [symbol] s allocation)—the rest of the indexes that were not allocated to pilots ? On the rest of the Data Sub-Channels (if allocated) they are defined as the indexes ranging from 0 to 99 (the last carrier on those Data Sub-Channels are neglected).

### 8. Signal Constellation and Mapping

The Modulation that can be used by each Subscriber-Unit can be one of the next: QPSK, 16QAM, 64QAM. The modulation scheme used is defined by the base-Station through MAC messages.

The data entering the mapping enters sequentially after the convolutional encoding, then it is mapped by the next constellation, the mapping is done in groups of bits (depending the modulation chosen) onto a complex number z, see FIGS. 28, 29 and 30.

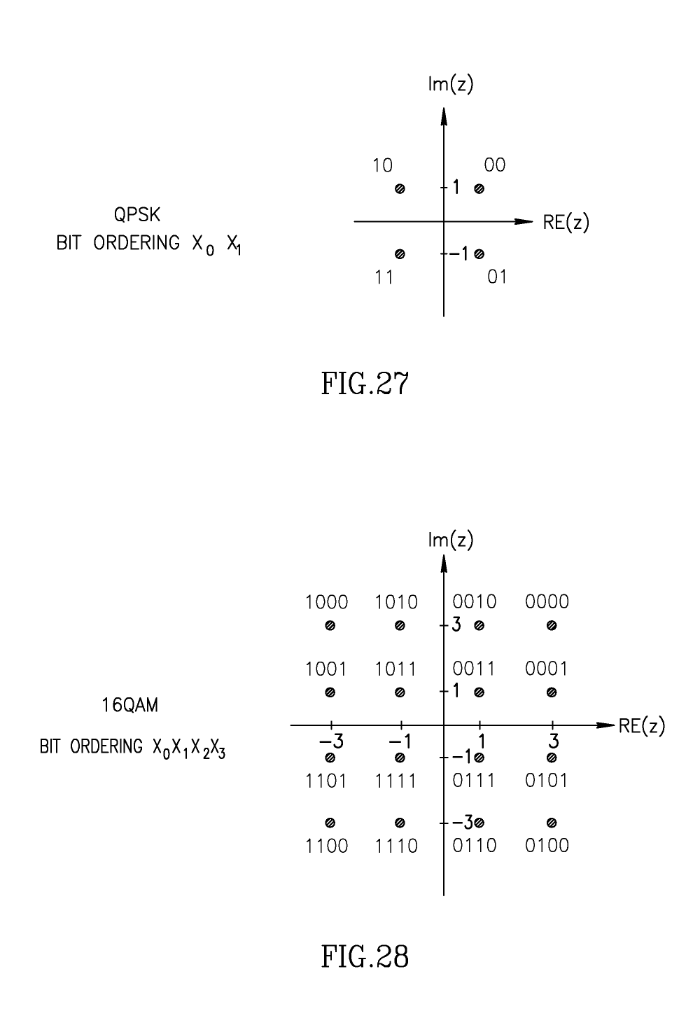

FIG. 27 details the QPSK mapping and bit pattern.

The real and imaginary components of the signal form four distinct states, as illustrated.

FIG. 28 details the 16QAM mapping and bit pattern.

The various combinations of real and imaginary components of the signal form 16 distinct states, as illustrated.

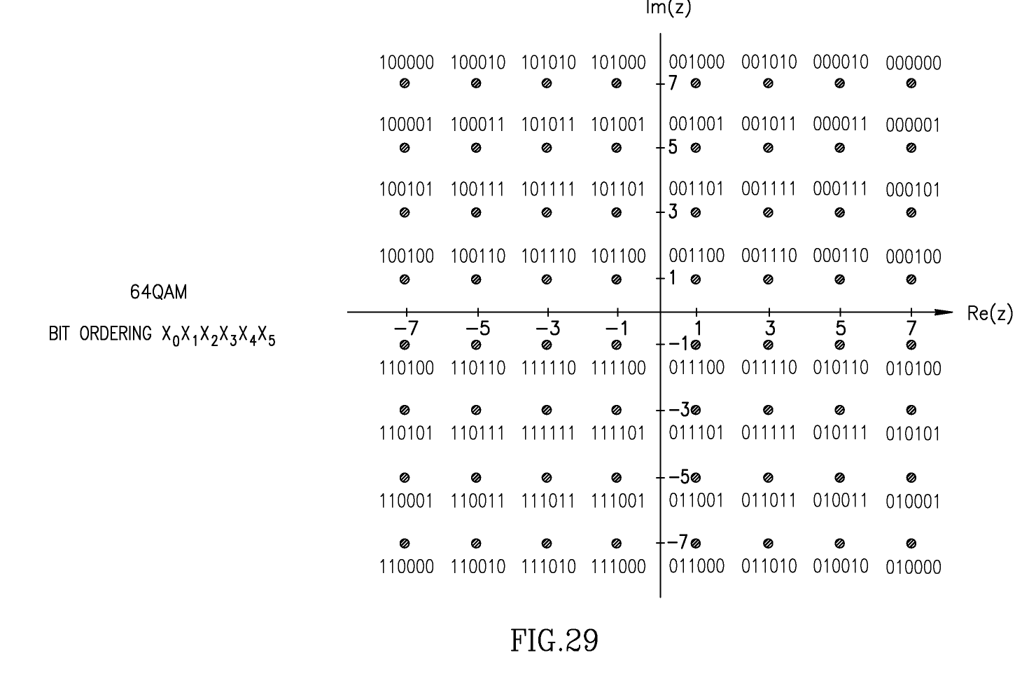

FIG. 29 details the 64QAM mapping and bit pattern.

The various combinations of real and imaginary components of the signal form 64 distinct states, as illustrated.

In order to keep the energy of the constellation constant ( ), the number z is normalized to c before mapping into the carriers by the next table:

The complex number c is then mapped onto the data carriers sequentially, when more than one Sub-Channel is allocated to a Subscriber-Unit the data is mapped in the same way (sequentially by the carrier index within the OFDM frame, as described in section 6 above).

### 9. Pilot Mapping

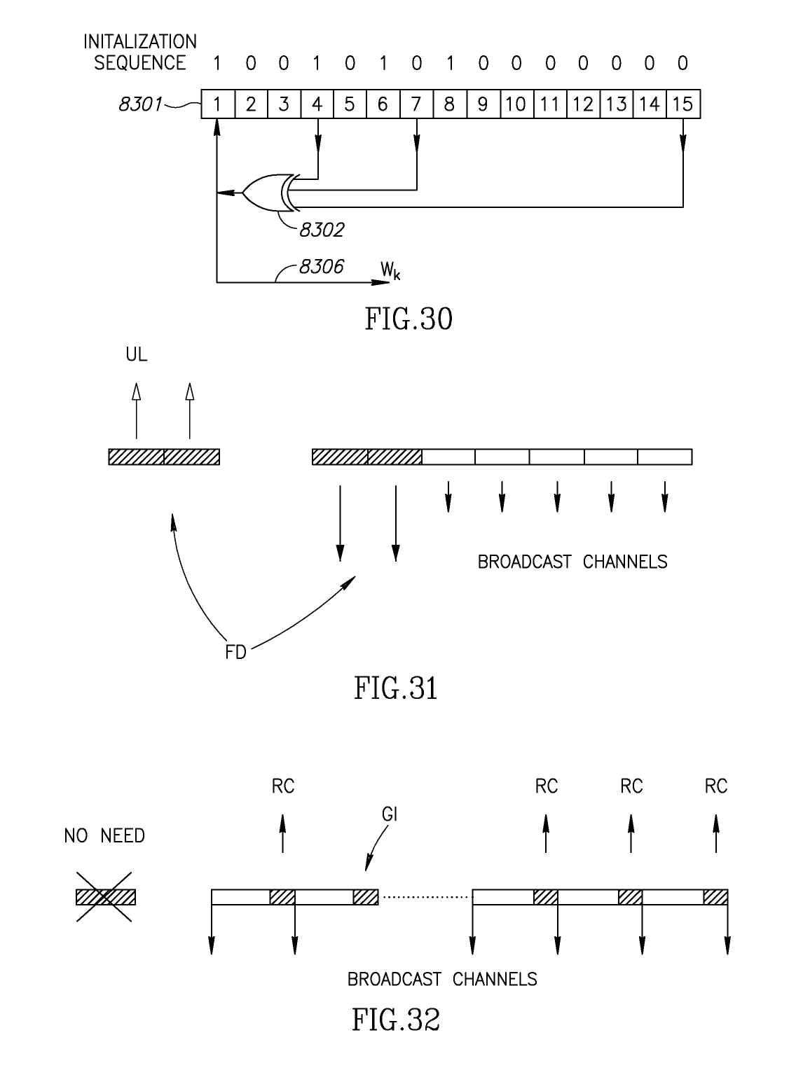

The pilots which are mapped by each Subscriber-Unit (see section 7 above) are mapped by the following modulation (no matter what is the chosen data modulation):

Where k denotes the index of the pilot (corresponding to the 1717 carriers used over one OFDM symbol), and is the bit value at the k position produced by the next PRBS, described in FIG. 30. The polynomial generator shall be.

FIG. 30 details the contention PRBS coder producer schematic diagram.

A XOR gate 8302 receives outputs 4, 7 and 15 from shift register 8301 and feds the XOR product back to the input of the shift register to generate a pseudo-random sequence.

The sequence thus generated is output as signal Wk at output 8306

The shift register has to be initialized to a specific state, as indicated in the figure, to generate the desired sequence.

### 10. Data Capacity and Coding Per Subscriber Unit

A Subscriber-Unit that has been allocated a Sub-Channel or several Sub-Channels for the transmission sends its data on the data carriers it has been allocated. The RS coding used (decided by the MAC) influences the data that is sent on the Up Stream.

The calculations of how many RS frames to encode and their structure is calculated by, first knowing the amount of symbols to be sent on the frame, this is the number of carriers that are to be used for data transmission (this is the number of all carriers dedicated to the user subtracting the number of carriers to be used as pilots). Then we calculate the amount of bits to be sent by multiplying the number of symbols to be sent by the modulation bps/Hz capacity.

This number is the amount of bits to be sent after the convolutional encoding, dividing this number by 4/3 we get the number of bits to be send before the convolutional encoding. The calculations of the RS frames to encode is done by knowing the amount of bits to be sent after the RS encoding which is the amount of bits to send before the convolutional encoding. We then use the MAC decision (about the amount of bit groups to be sending as protection of the RS) in order to build the RS frames. The RS frames are filled if possible and encoded, and padded with zeros before encoding (shortened code) for the last frame if needed.

Let us take as an example some cases, where one sub-channel has been allocated, and we use only 4 bit groups as the RS protection (4 erasures):

Number of Pilots Bits before RS encoding RS(31,23) structure with 4 erasures RS bit groups after encoding Bits after Convolutional encoding Data Symbols after mapping QPSK 11 115 23 27 180 90 21 100 3 zero padding+20 24 160 80 51 55 12 zero padding+11 15 100 50

Number of Pilots Bits before RS encoding RS(31,23) structure with 4 erasures RS bit groups after encoding Bits after Convolutional encoding Data Symbols after mapping 16QAM 11 230 23,23 54 360 90 21 200 23, 6 zero padding+17 48 320 80 51 110 12 zero padding+11, 12 zero padding+11 ** 30 200 50 ** Special case

Number of Pilots Bits before RS encoding RS(31,23) structure with 4 erasures RS bit groups after encoding Bits after Convolutional encoding Data Symbols after mapping 64QAM 11 345 23,23,23 81 540 90 21 300 23,23, 9 zero padding+14 72 480 80 51 165 23, 9 zero padding+14 45 300 50

All other RS structures and number of bits transmitted can be calculated by using the explanation above (full tables and calculations shall be supplied as needed).

FIG. 31 illustrates the spectral characteristics of FDD.

11. Frame Structure: The Time Frame structure of the up-Stream as defined above, may comprise 16 OFDM symbols (in a DVB-T super frame there are 17 Down-Stream Time Frames). The parameters of the Down-Stream are defined in the next table (only 2 k mode):

Parameter “2 k” mode: Number of Usable Carriers 1717 Number of carrier number 0 Number of carrier number 1716 Duration

Carrier spacing: 4464 Hz Spacing between carriers and 7.66 MHz

In one embodiment, the following data indicate the allowed guard interval duration (2 k mode only):

| Guard Interval | ¼ | ⅛ | 1/16 | 1/32 |
|---|---|---|---|---|
| Duration of guard | 56 | 28 | 14 | 7 |
| interval | | | | |
| Symbol duration | 280 | 252 | 238 | 231 |

Notes:
1. All the time intervals are in microseconds.
2. Duration of Symbol part = 224 microsec in all the above cases.

### More RC Calculations

The next calculations are for the Down-Stream transmissions.

Bandwidth=8 MHz (7.66 MHz used)

OFDM Carriers=2048

Carriers in use=1717

Sample Rate=64 MHz/7=9.16 MHz

Carriers Distance=Bandwidth/Carriers in use=4464 Hz

Number of Carriers used for Uplink contention=101

Number of Sub-Channels per OFDM frame=16 Subchannels

Number of carriers per on Sub channel allocation=101 carriers

Pilot Carriers per Subscriber Unit=11,21,51,101 carriers

Data carriers assuming n Subchannel for a specified Subscriber Unit (n ranging from 1 to 16)=100*(n−1)+101−NumberOfPilots

Data carriers assuming 1 Subchannel and 11 pilots allocation per

Subscriber-Unit=101-11=90 carriers

Symbol rate on this Sub-Channel allocation, assuming 1/32 guard interval=(90*16) Carriers/Frame Duration=6.234 Msps

Bit rate on this Sub-Channel allocation, assuming 1/32 guard interval, and average 3 bps/Hz=6.234 Msps*3=18.7 Mbps

Data carriers assuming 16 Subchannel and 101 pilots for a specified Subscriber Unit=100*15+101 [symbol] 101=1500 carriers

Symbol rate on this Sub-Channel allocation, assuming 1/32 guard interval=(1500) Carriers/Frame Duration=6.494 Msps

Bit rate on this Sub-Channel allocation, assuming 1/32 guard interval, and average 3 bps/Hz=6.494 Msps*3=19.48 Mbps

### Simulation Results

The following simulation results are of a RC with the next parameters:

Subscriber-Unit #1 #2 #3 Modulation 64QAM 16QAM QPSK Pilots Used 51 21 11 Sub-Channels allocated 0,4,6,8,11,13,15 1,3,5,7 2,10,12,14

New Subscriber-Units #1 #2 #3 CDMA Code Used 1 5 11

All Subscriber-Units Suffer Different Multi-Paths and different Attenuations

### Interactive DVB-T RC

According to another aspect of the invention, the present invention may also be used in Interactive DVB-T. Design and implementation methods of a broadband Return channel are achieved, which may better utilize the OFDM technology as the access solution for the return channel.

The DVB-T return channel should provide a proper complementary communication link to the Broadcast link in the same way as it is set in DVB-C, DVB-S and MCNS. However, the wireless solution has to provide the service to residential users through a directional antenna or in-home Omni antenna, and equally to provide DVB-T services to nomadic or mobile subscribers, as it is planned in different regions in the world.

### Frequency Allocation

Currently, each country has several dedicated broadcast (B.C) frequencies which we propose to utilize, as much as possible, for the benefit of the return channel. The return channel has to be a broadband channel, on one hand, to answer the need of the required applications and on the other hand, the channel should be efficient in spectrum usage.

In addition, from the regulatory point of view, obtaining additional frequency bands apart from the currently available broadcast frequencies is quite a problem and more expensive for the user, due to the need an additional FR head in the user terminal. To mitigate the problem, Runcom proposes the above mentioned optional solutions utilizing, in some options, the allocated broadcast frequencies bands.

### TDD/FDD Options-Comparative Analysis

Recently, there is awareness of the fact that the bandwidth provided by DOCSIS and DVB-C are not sufficient.

In USA, for instance we witness a shift of subscribers from cables to ADSL There is a need, therefor, for more fundamental solution capable of offering the required bandwidth for customers using the DVB-T service thus facilitating its rapid proliferation. In face of the fierce competition with satellite video broadcast and DVB-C there is a need for a substantial enhancement of the Interactive DVB-T through the specification and adoption of a broadband Return Channel enabling full fledged interactive services.

There exist many options for broadband RC, some resort to allocation of additional channels, other options are not. Probably the trivial solution can be similar to the approach adopted for the Interaction channel for cable TV where several channels are assigned to downstream and several channels to the upstream transmissions and other dedicated channels for video broadcast see FIG. 32.

FIG. 32 illustrates the characteristics of TDD.

The drawback of this approach is the need for a dedicated allocation of channels for UpLink (UL) use. More than that, several broadband channels are desirable in order to improve Statistical MUX. We propose, as an adequate solution, two options which enable Broadcaster, who are denied grant of additional spectrum resources or channels, to exercise and maintain a broadband Return Channel.

The optimal option is the use of Guard Intervals (GI) and thus to gain a large bandwidth, for example—Use of GI (¼) on ten frequencies will result in gain of 20 MHz which could be dedicated fully for the return channel. We are aware of the fact that ASIC developers have used the GI for prefix transmissions being utilized in the DVB-T receivers for the synchronization of FFT frames, but at the cost of degraded performance in presence of multi-paths of long duration, and also in SFN environment where extremely long duration of multi-paths can be expected.

Runcom's experience in the development of its DVB-T receiver indicates that a better performance can be achieved in synchronization to pilot PN series instead. Other reason, in favor of the GI approach, is the simplicity and the great saving in the complexity of the user terminal, since in the cable TV like solution there is a need of dual tuners and an additional transmitter which drive up the cost substantially.

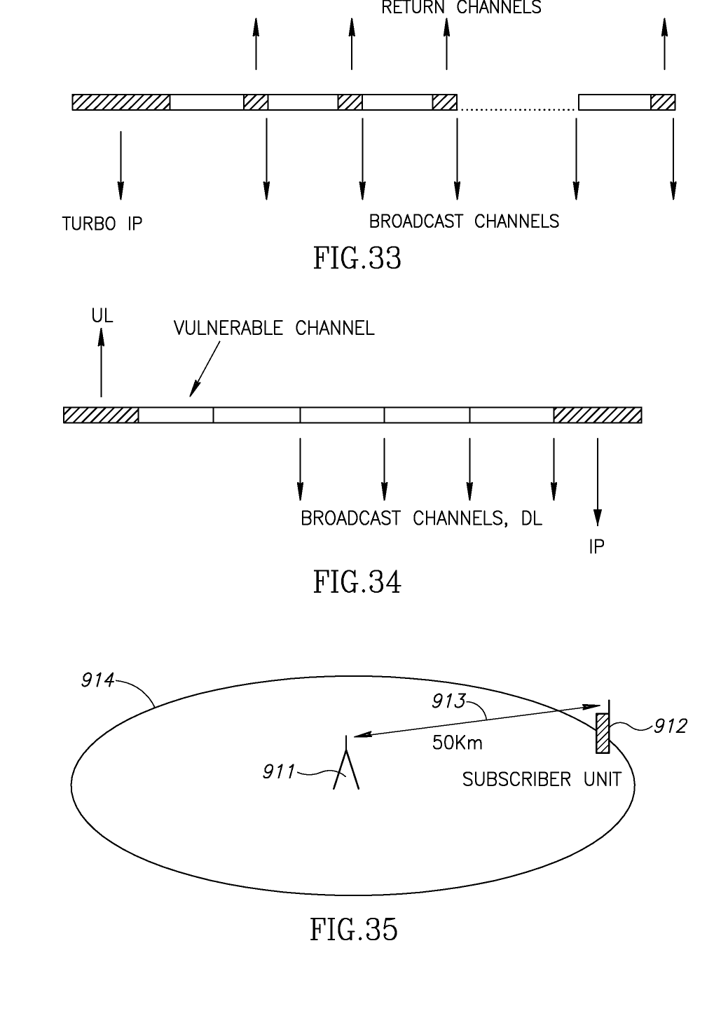

FIG. 33 illustrates the characteristics of TDD in a SFN environment.

Utilization of GI will allow us a gain of between 1/32 up to ¼ of the bandwidth. For instance for each existing channel (DL+GI) and use of 64 QAM we can, theoretically, reach on the Return Channel a capacity of 2 up to 6 Mbps with the following division between DL and RC:

A broadcaster who has at his disposal 10 channels, for example, can gain an aggregate of 20-60 Mbps on the Return Channel. In the case of a Broadcaster using GI=⅛ (for instance in UK) we can gain 2.5 Mbps on each broadcast channel. Sharing the same frequency for the broadcast and the return channel will allow the user equipped with a rather simple Transceiver to watch TV, to access IP and to operate a telephone (VoIP, or voice to PSTN). Further discussion will tackle the issue of service in the environment of SFN deployment and the probable impairment that could result when using GI option.

Obviously, it is desirable and worth to designate one Down-link, without video broadcast, for the sole use as an IP channel (TURBO-IP). The up link will use GI and the IP down-link will not carry video broadcast. The subscriber has to switch to other channel to watch TV. This scheme entails addition of tuner for IP channel, however this scheme has the benefit of resolving the issue of proper operation in SFN environment (see FIG. 34).

FIG. 34 illustrates the characteristics of in-band FDD.

A third option can be considered (FIG. 35), apart of the GI options, which call for the allocation of two broadcast channels for the benefit of the Return Channel and IP service.

FIG. 35 illustrates the conventional coverage with one base station. It illustrates a base station 911, subscriber unit 912 with a distance between user and base station 913. There is a cell cover area 914.

This approach requires a proper isolation between reception and transmissions as it is the case when using the GI option. The isolation between transmit antenna and reception antenna of 70 db, in the Base Station can be easily achieved on separation between the Transmitter site and the receiver site.

Further more, we have to reduce adjacent channel interference by additional 80 db in order to keep for the adjacent channel a high dynamic range of 150 db.

However, on the subscriber side there is no such possibility for the separation between antennas, therefore we have to adopt FDD mode whereby the IP reception is confined to the farthest channel.

There exists several methods for the division between transmission and reception, however the two modes of FDD and TDD using GI have the potential for a viable solution for the return channel.

### The Novel Interactive DVB-T RC

Some optional coverage configurations for a large region and the issues involved are presented. The optimal coverage configuration and density of deployment of the Base Stations should take into consideration potential users population and preferred types of services. Rigorous frequency management and frequency reuse scheme is being treated in the technical paper submitted by Runcom to RCCL2. The following types of coverage are considered:

Rural Fixed Urban Fixed (Outdoor antenna) Urban Fixed (Indoor antenna Rural Mobile (Omni antenna) Urban mobile (Omni antenna)

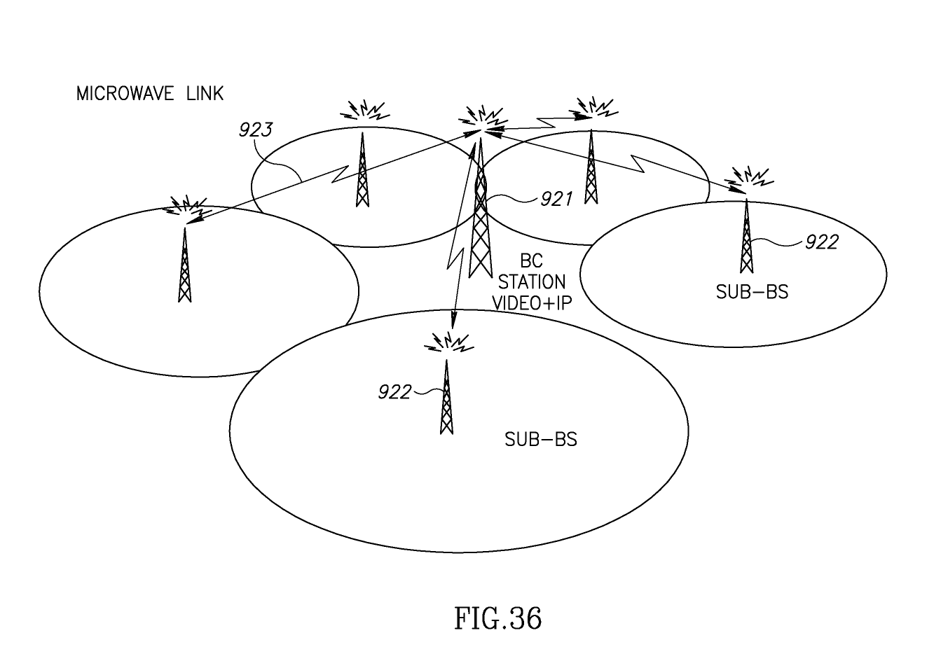

### 1.1 Conventional Coverage (FIG. 36)

FIG. 36 illustrates coverage with a dense deployment of base stations. There is a BC station, video+IP 921, connected to several sub-BS 922 through a microwave link 923.

In order to keep a reasonable transmission power on the return channels from distant subscribers there will be a need for directional antenna to be also installed at private users premises. In such a case we are trading off range with bandwidth. Along the course of our discussions we will show that CODMA based solution is an adequate solution and in fact can extend and improve the currently proposed narrow band solution.

### 1.2 Coverage of Urban Regions—Fixed

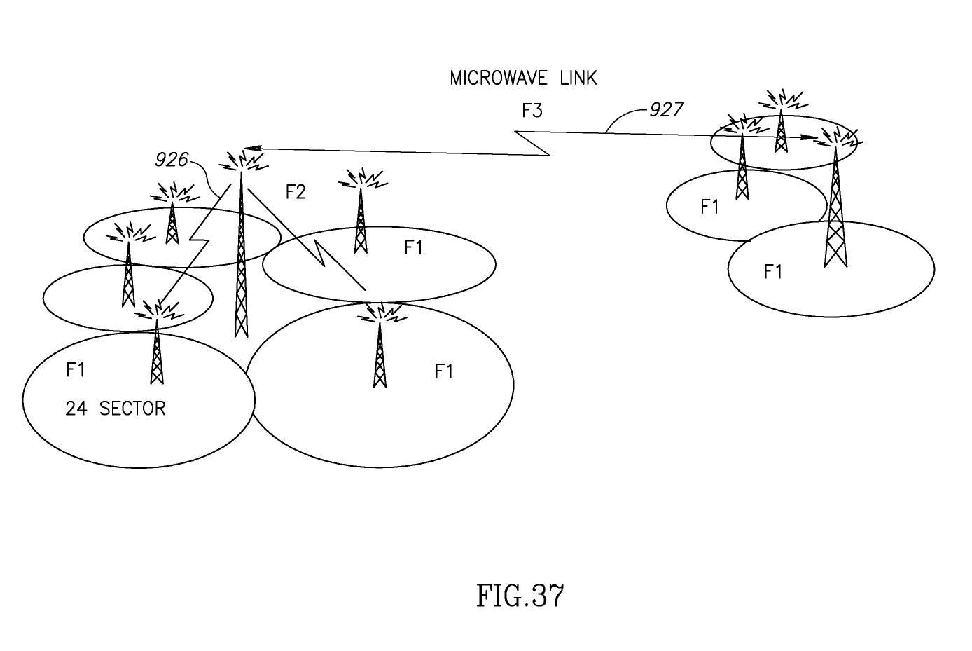

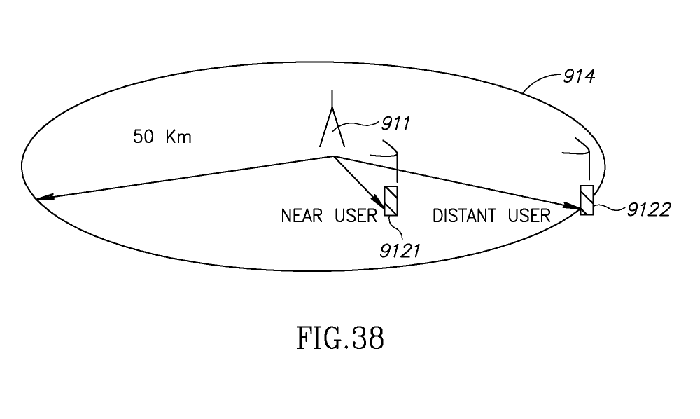

Shadowing problems are usually experienced in urban areas, therefore in order to reach every single home and enable reliable transmissions from users we can decrease area of the cells and thereby remove limitations on propagation and system capacity. FIGS. 37, 38 describe such probable deployment of Sub-Base Stations (Sub-BS).

FIG. 37 illustrates coverage with an SFN deployment of base stations. There is a first cells cluster 924 at frequency F1 and second cells cluster 925 at frequency F1, with microwave links 926 at frequency F2 and microwave links 927 at frequency F3 connecting therebetween as illustrated.

FIG. 38 illustrates rural coverage.

The system may include a base station 911, a near subscriber unit 9121, a pluality of distant subscriber unit 9122. The distance between user and base station 913 is illustrated, as well as the cell cover area 914.

### Sub-BS Overall Functionalities:

1. Distribution of Video broadcast to subscribers
2. Reception of IP messages addressed to specific subscribers and forwarding these IP messages to subscribers.
3. The reception and management of uplink traffic from different users:

Traffic from fixed user is decrypted and transferred to Base Station for distribution to final destination, to ISP, Video Server or to other networks such as PSTN/ISDN.

Traffic from mobile user:

4. Simultaneous reception of transmissions from mobile users on the regional level by several Sub-Base Stations, processing of the mobile transmissions by each Sub-Bs and the transfer of the processed data to a central Base Station where the data is being combined, MRC, and transferred further along the chain.
5. Registration of subscriber on performing Hand Over and the notification of the switching system in order to route the destined messages to the subscriber to the new Base Station.

Base Station Capacity, calculated for the following parameters: ? 24 Antenna Sectors ? Use of one frequency, F1 ? Radius of area cell-Up to 10 km ? Modulation-16 QAM ? GI=¼ ? Code Rate, ⅚

Total UpLink capacity (Base Station level)=99.36 Mbps

### 1.3 Mobile Users in Urban and Rural Areas

In several regions there is the intention to provide mobile DVB-T services. In this sense, mobility can be either nomadic/walking mobility or travelling mobility. The user should be capable to exercise two way communication and the use of interactive services, regardless of type of coverage configuration. One of the important considerations in the deployment of Base Stations should be type of coverage and size of area cell that could enable mobile users equipped with Omni antenna to maintain a reliable communication. Mobile DVB-T service, augmented with interactive service, will be an important differentiation factor boosting proliferation and the popular use of DVB-T.

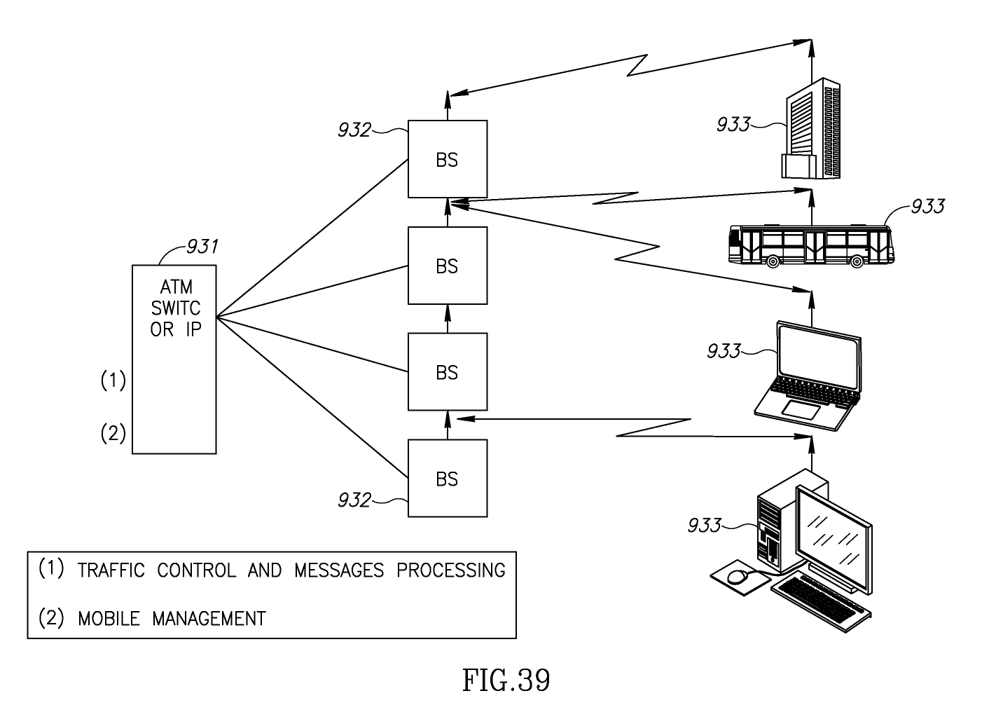

### 2 Fixed Rural (FIG. 39)

FIG. 39 details the structure of a distributed system.

It may include an ATM site 931, a plurality of BS units 932 and a plurality of users 933.

1. The subscriber is able to receive Video broadcast.
2. The subscriber is able to receive packet messages addressed to him.
3. The subscriber is able to transmit Packet messages according to the Base Station's allocation of modulation method and bandwidth. The power level and S/N of the subscriber transmissions are being monitored continuously at the Base Stations and the Subscriber terminal is instructed to shift to proper modulation and bandwidth to maintain reliable communication between the subscriber and the Base Station. For example: for near subscribers—64 QAM; for intermediate distances—16 QAM; for remote subscribers—4 QAM
4. Use of Directional antenna at user premises.

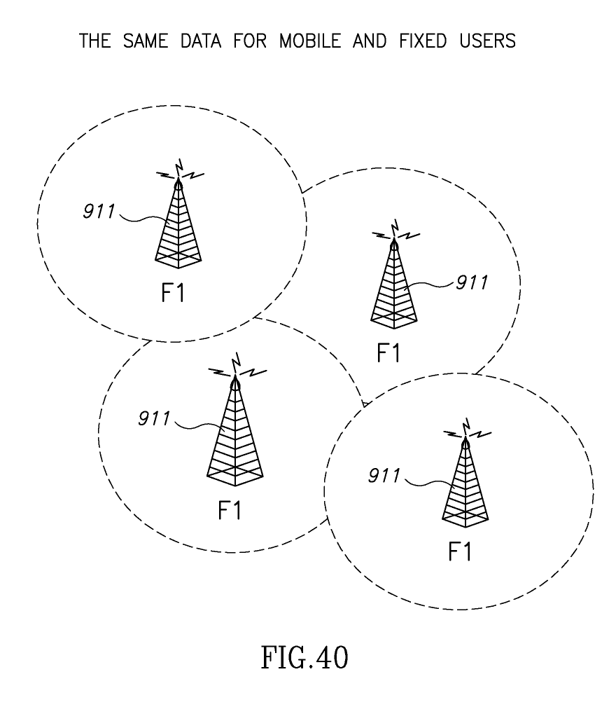

FIG. 40 illustrates the structure of a broadcasting SFN system.

It may include a base station 911.

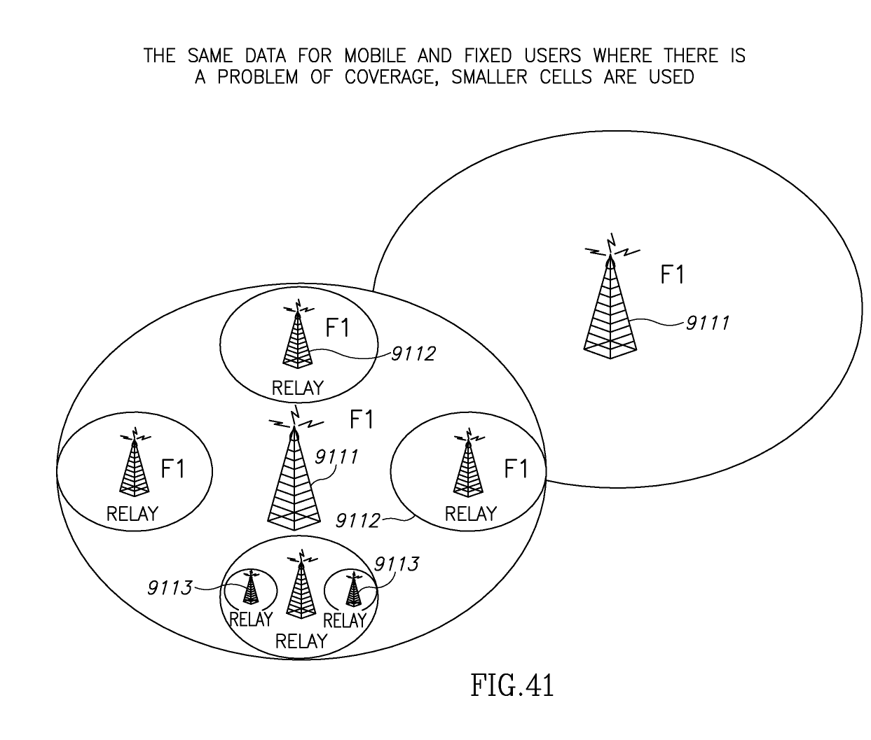

FIG. 41 illustrates the structure of a broadcasting SFN system with indoors antennas. It may include a large base station 9111, a relay for medium-sized cell 9112 and a relay for small cell 9113, or a plurality thereof.

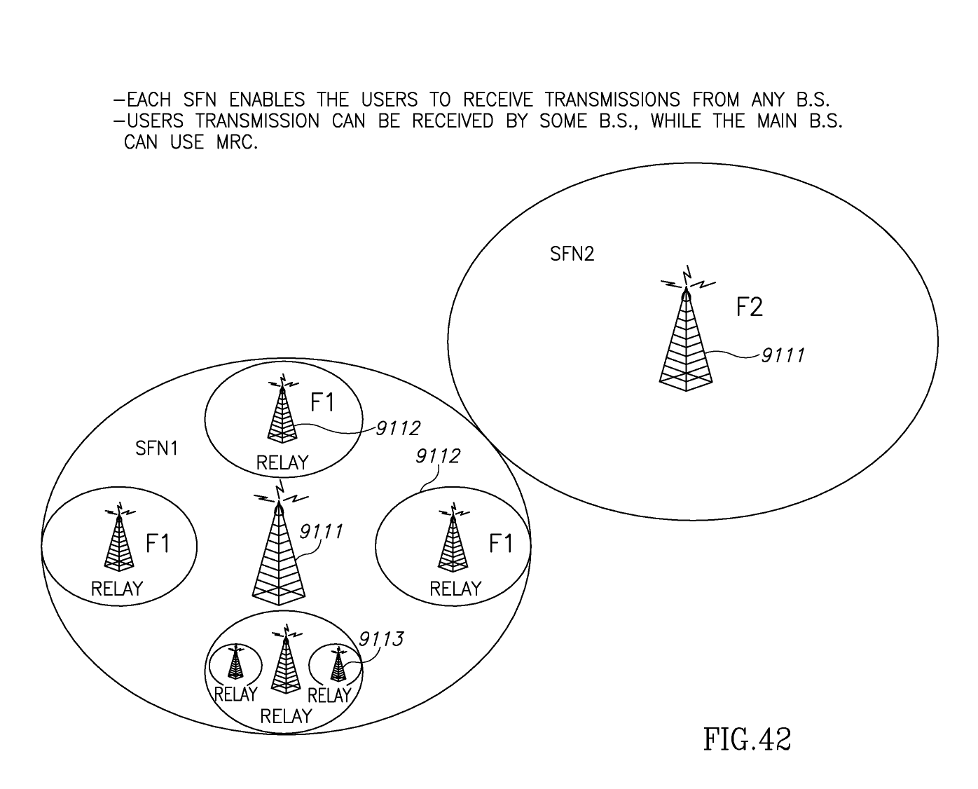

FIG. 42 illustrates a local SNF with interactive services.

There is a large base station 9111, which may use different frequencies, like F1 and F2, as well as a relay for medium-sized cell 9112 and/or a relay for small cell 9113.

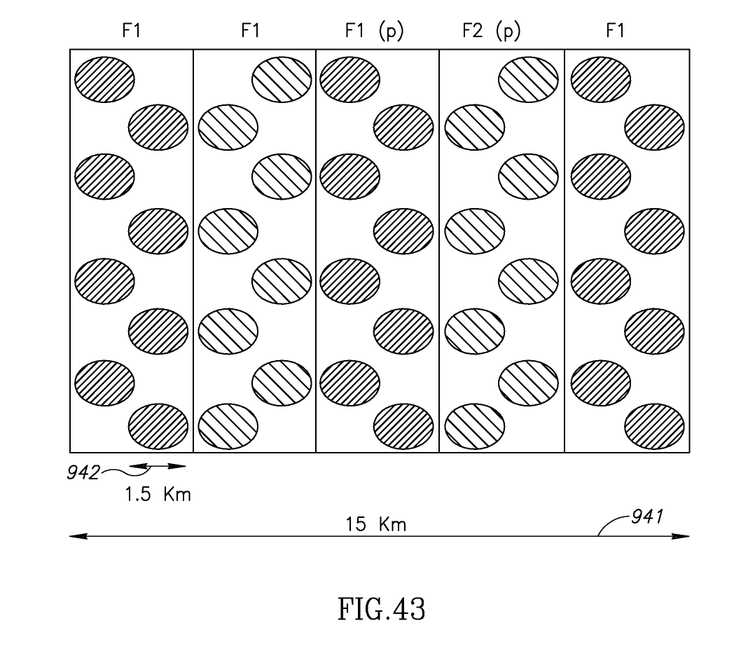

FIG. 43 details SFN reuse for slow mobility or indoors antenna. It may relate to a large distance 941, for example 15 km, and smaller distance 942, for example 1.5 km.

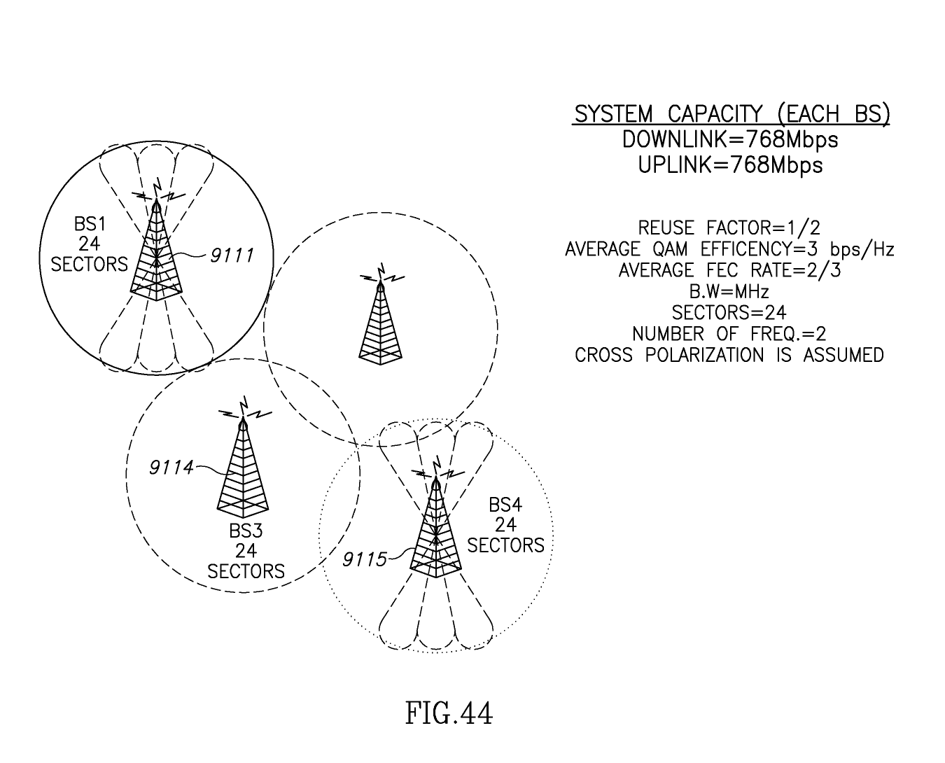

FIG. 44 details a deployment for interactive services for fixed users.

The system may include a plurality of base stations 9111, 9114, 9115, each uses sectors for example 24 sectors.

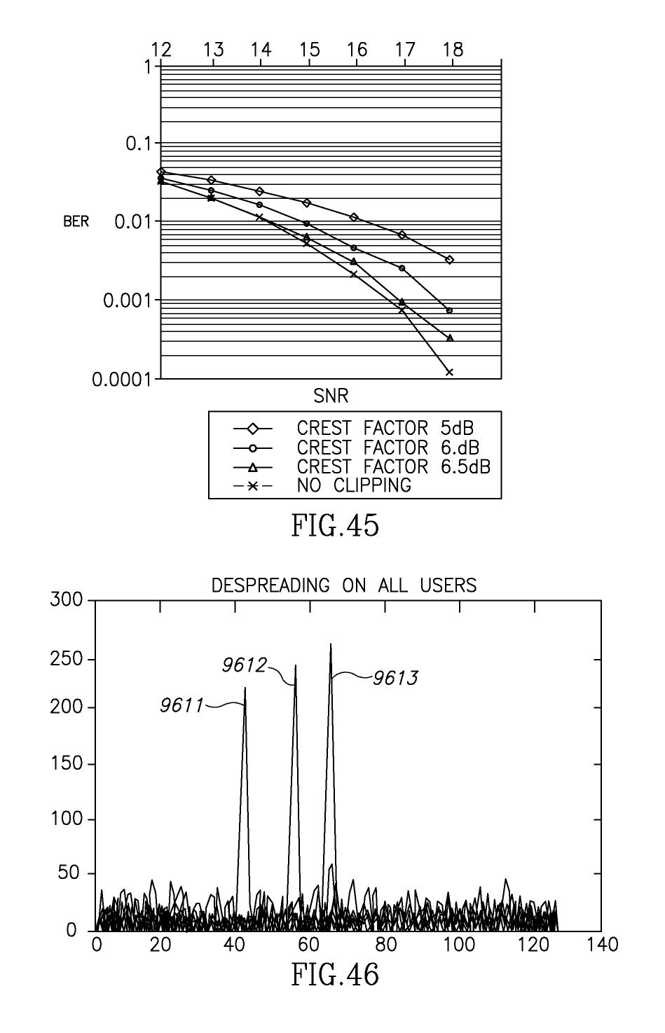

FIG. 45 illustrates the achievable Bit Error Rate (BER) as a function of the Signal to Noise Ratio (SNR). The parameter is the crest factor in the modulated signal.

### 2. Types of Services

The proposed TDD/FDD solutions should equally answer identified needs in the broadcast market and the telecommunication market and also the integrated services envisaged for future convergence of these markets. The aim is also to complement the mobile DVB-T with the same capabilities, namely broadcast and telecommunication services, such as: 1. IP 2. Telephony-VoIP 3. Video Broadcast 4. HDTV 5. Telephony for business-E1, FRAC E1, 6. Mobility 7. Individual services 8. E-commerce 9. Integrated services to private and business users-Video, voice and data

### 2.1 Interfaces

The interfaces should comply with DVB standards, in the same way as Interactive return channel for cables (RCC) relates to ETS 300 800 standard and DVB-namely, use of ATM or MPEG2 over ATM or IP. The network connecting the base stations to Region Station, or higher echelon station, should include ATM switch capable of managing several Base Stations (BS). The heavy UpLink traffic from users including TV, NxIP and telephony from large buildings, buses (One TV, IP and telephone for each chair), PC's and LapTop's enhanced with telephone should be possible to be conveyed from the base stations to the ATM backbone network.

Traffic control and local messages processing (2) Mobile management

### 2.2 Subscriber Interface

The subscriber interfaces could include one or more of the following interfaces: ETH, USB, PCFCIA for LapTop, Nx Rj11 for telephony, Video coax for TV connection, etc

### Broadcasting SNF

According to yet another aspect of the invention, the same frequency may be used in a celluar network for broadcasting to mobile users, wherein the system also provides for a return channel.

### Customers and Mobility

The system may address a mutitude of user types:

Fixed Users—Residential, Businesses (Set Top Boxes)

### Slow Mobility Users—Neighborhood (PC Cards, Set Top Boxes)

Fast Mobility Users—Cars, Trains, Buses (Wireless WAN)

### Capacity

Use modulations with various Bit/Hz capabilities as Adaptive N-QAM.

Use Adaptive FEC (Reed-Solomon & Viterbi)

Maximal frequency reuse between cells/sectors (close to 1).

Maximum sectors allocation.

The use of statistical muxing and concentration.

Adaptive Sub Channels Allocations.

Bandwidth on Demand (BOD)

The capability to supply users needs upon demand:

64 Kbps 32 Mbps in 64 Kbps steps (DVBT 8 MHz)

64 Kbps 24 Mbps in 64 Kbps steps (MMDS 6 MHz)

64 Kbps 112 Mbps in 64 Kbps steps (LMDS 28 MHz)

Large Scope of Service

Supplying services as POTS, ISDN, IP, ATM and other Packet Switching or Circuit switching data in the same access method while keeping the necessary QOS.

FIG. 46 illustrates results of a simulation with use of contention pilots. The simulation illustrates the results of a method for finding new subscriber units requesting services, using the contention pilots.

This is an implementation of the CDMA/OFDM techniques.

The results indicate three spikes 9611, 9612 and 9613, corresponding to three users respectively.

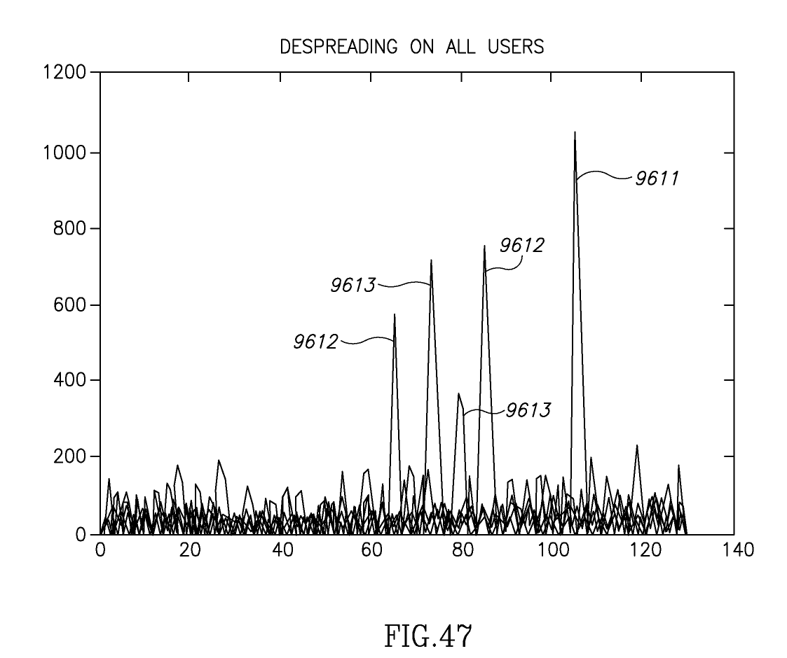

FIG. 47 illustrates results of a simulation with contention pilots and multipath.

The multipath, in this case, results in a plurality of spikes 9612 and 9613.

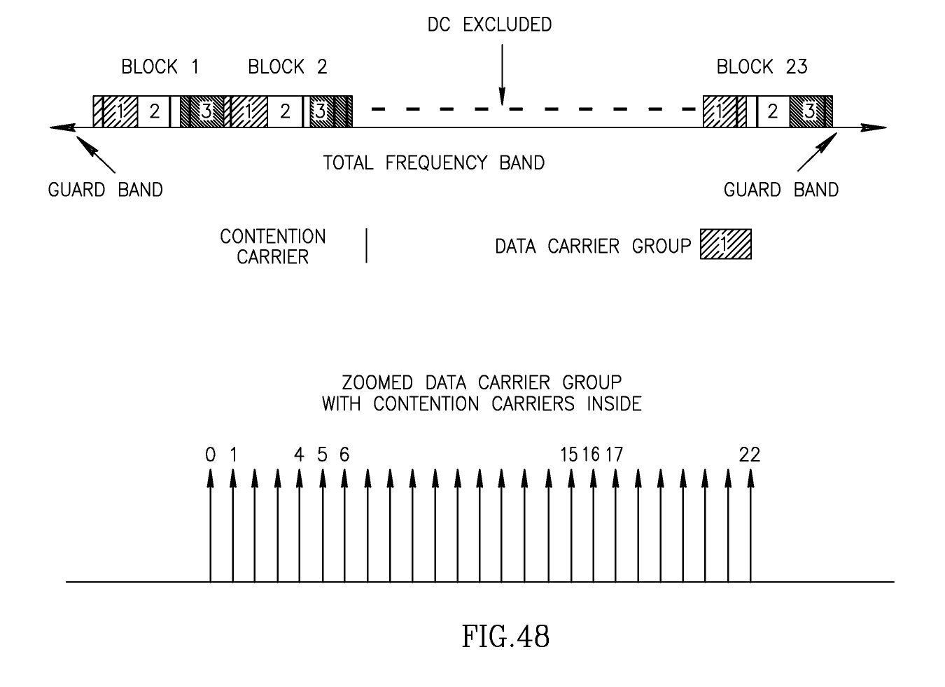

FIG. 48 illustrates a burst structure planning in the frequency domain. It details the burst implementation for carrier allocation.

### 2K Mode Structure:

Number of FFT points=2048 (2K)
Used carriers=1704. DC carrier is excluded for RF simplicity
Guard bands=172 (at the high end—the right side—of the spectrum), and 171 on the left side.
Number of contention carriers for CDMA sync=117. This results in a processing gain of 20.7 dB
Number of useful data carriers=1587 (69 groups of 23 carriers each).

The numbers on the subcarriers as illustrated (Nos. 0, 1, 4, 5, 6, 15, 16, 17, 22) indicate these subcarriers are used for contention, and are not included in the sequence numbering.

### An Adaptive Modulation Method

According to the invention, a method for adaptive constellation modulation transmissions comprises the steps of:
A. measuring the channel performance for each user
B. setting a modulation scheme for each user responsive to the measured channel performance.

In one embodiment of the invention, for example:

For high quality users the modulation is 256 QAM or 256 DAPSK, for intermediate quality users the modulation is 64 QAM or 64 DAPSK, for lower quality users the modulation is 16 QAM or 16 DAPSK, and for low quality users the modulation is 4 QAM or 4 DAPSK.

The channel performance may indicated, for example, in the received signal quality and depending on the transmitted constellation for each user by MAC message.

The system may use pilot signals in the transmitted signal for recovering the clock of the base station and for using the clock as reference for all transmissions from the subscriber.

The pilot signals in the transmitted signal may be used for contention and synchronization, wherein the pilots are modulated in the frequency domain using one or more PN sequences.

In the above detailed method for adaptive constellation modulation transmissions, the pilot signals are used to compute signal characteristics. These characteristics may include the time of arrival, received power and multipath. These characteristics are then used for adaptive modulation.

In the above method for adaptive constellation modulation transmissions, it is possible to add a cyclic prefix to the transmitted signal.

Thus, the Base Station copes with users transmission not arriving fully synchronized, and relieving the demand of precise user's synchronization.

To that purpose, a cyclic prefix may be added, wherein the prefix is the data transmitted at the end of a time interval.

The addition of that prefix reduces the sensitivity to timing errors in the time of arrival (TOA) to the extent of the guard interval (GI) value.

According to another aspect of the invention, subcarriers are dynamically allocated to subscribers responsive to the quality of the communication link. Thus, a first user experiencing a better quality link at a given moment will be allocated more subcarriers, that will allow that user to transfer a large volume of data in a short time. Thus, the opportunity of a good link is used to transfer more data, more efficiently.

In contrast, a second user with a low quality link will only be allocated less subcarriers, since there is no point in allocating more resources in a link where information will be wasted anyway.

The above refers to systems decisions at a given moment in time. At a different time, the quality of the second user's link may be better, and then that user will be allocated more carrier, for efficient transmission of large volumes of data.

The system continuously monitors the quality of the link for each subscriber, and dynamically allocates bandwidth (number of subcarriers) to each subscriber according to the measured link quality. A larger bandwidth is allocated to users experiencing better quality links. The above subcarriers allocation may be maintained for a predefined time period; for the next time period, the subcarriers allocation may be changed, responsive to a new set of measurements of subscribers' link quality.

Thus, a method for adaptive constellation modulation transmissions was disclosed.

It uses a dynamic subcarriers allocation to subscribers, wherein more subcarriers are allocated to subscribers who achieve better communications at a given time. This method may be advantageously used to increase system throughput.

It will be recognized that the foregoing is but one example of an apparatus and method within the scope of the present invention and that various modifications will occur to those skilled in the art upon reading the disclosure set forth hereinbefore.

What is claimed is:

1. In a wireless broadband system comprising a base transmitting to a plurality of subscribers, a method for adaptive constellation modulation transmissions comprising the steps of:
A. measuring the channel performance for each user
B. setting a modulation scheme for each user responsive to the measured channel performance; and wherein for high quality users the modulation is 256 QAM or 256 DAPSK, for intermediate quality users the modulation is 64 QAM or 64 DAPSK, for lower quality users the modulation is 16 QAM or 16 DAPSK, and for low quality users the modulation is 4 QAM or 4 DAPSK.

2. The method for adaptive constellation modulation transmissions according to claim 1, wherein the channel performance is indicated in the received signal quality and depending on the transmitted constellation for each user by MAC message.

3. The method for adaptive constellation modulation transmissions according to claim 17, further using pilot signals in the transmitted signal for recovering the clock of the base station and for using the clock as reference for all transmissions from the subscriber.

4. The method for adaptive constellation modulation transmissions according to claim 1 further using pilot signals in the transmitted signal for contention and synchronization, wherein the pilots are modulated in the frequency domain using one or more PN sequences.

5. The method for adaptive constellation modulation transmissions according to claim 20, further using the pilot signals to compute signal characteristics including the time of arrival, received power and multipath, and for using said characteristics for adaptive modulation.

6. The method for adaptive constellation modulation transmissions according to claim 1, further using a dynamic subcarriers allocation to subscribers wherein more subcarriers are allocated to subscribers who achieve better communications at a given
